(19) United States
(12) Patent Application Publication
(10) Pub. No.: US 2012/0052899 A1
(43) Pub. Date: Mar. 1, 2012

(54) Wireless Communication System, Base Station Device, and Program

(76) Inventors: Xiaoqiu Wang, Fujimino-shi (JP); Satoshi Konishi, Fujimino-shi (JP); Noriaki Miyazaki, Fujimino-shi (JP)

(21) Appl. No.: 13/218,524

(22) Filed: Aug. 26, 2011

(30) Foreign Application Priority Data
Aug. 30, 2010 (JP) 2010-192866
Sep. 28, 2010 (JP) 2010-216758
Sep. 29, 2010 (JP) 2010-219160

(51) Int. Cl. H04W 72/08; H04W 36/32

(52) U.S. Cl. 455/513

(57) ABSTRACT

A wireless communication system includes a macro-base station device and a CGS base station device normally connected to a CSG terminal device. When a non-CGS terminal device approaches the CGS base station device, the CGS base station device reduces a frequency band for transmitting packets to the CGS terminal device so as to reduce interference with the non-CGS terminal device while increasing transmission power to the CGS terminal device so as to compensate for degradation of radio quality due to a reduction of the frequency band. Based on existence or nonexistence of a non-CSG terminal device in the coverage area, the CSG base station device selects an appropriate antenna transmission mode and an appropriate scheduler mode while setting the number of OFDM symbols utilized by a physical control channel in notifying radio resource allocation information.

### BACKGROUND OF THE INVENTION

1. Field of the Invention

The present invention relates to wireless communication systems, base station devices, and programs implementing wireless communication methods and radio resource allocation methods.

The present application claims priority on Japanese Patent Application Nos. 2010-192866 (filed Aug. 30, 2010), 2010-216758 (filed Sep. 28, 2010), and 2010-219160 (filed Sep. 29, 2010), the entire content of which is incorporated herein by reference.

2. Description of the Related Art

Wireless interface standardization organizations, e.g. 3GPP (3rd Generation Partnership Project), have aimed to further improve frequency availability in 3rd generation wireless communication systems, e.g. W-CDMA (Wideband Code Division Multiple Access) and have been working on the standardization of successors to 3rd generation wireless communication systems, e.g. an LTE (Long Term Evolution) standard. The LTE standard adopts an OFDMA (Orthogonal Frequency Division Multiple Access) system as a wireless access system in the downlink transmission.

A wireless communication system adopting an OFDMA system is able to divide a system frequency range thereof into a plurality of subcarriers, which can be allocated to distinct terminal devices (i.e. UE: User Equipment) as traffic channels. Additionally, it is possible to dynamically change configurations of subcarriers and terminal devices allocated with subcarriers over time. That is, radio resources allocated to terminal devices are divided in a two-dimensional manner consisting of a frequency domain and a time domain, thus achieving a flexible allocation of radio resources in response to communication status.

The LTE standard implements a function of providing terminal devices with control signals representing time-variant allocation of downlink traffic channels (i.e. PDSCH: Physical Downlink Shared Channel), from base station devices to terminal devices, via downlink control channels (PDCCH: Physical Downlink Control Channel). Additionally, the LTE standard allows base station devices (i.e. eNB: evolved-Node B) to allocate uplink traffic channels (PUSCH: Physical Uplink Shared Channel), directing from terminal devices to base station devices. For this reason, base station devices forward control signals, representing allocation of PDSCH and allocation of PUSCH, to terminal devices by way of PDCCH packets. In order to allocate channels, i.e. either PDSCH or PUSCH or both of PDSCH and PUSCH, to terminal devices, base station devices allocate PDCCH resources to terminal devices, thus forwarding PDCCH packets, representing allocated channels, to terminal devices.

FIG. 6 shows a downlink sub-frame configuration with a system bandwidth of 10 MHz in the LTE technology. In the LTE standard, one downlink sub-frame is regarded as two-dimensional radio resources, which are divided into 600 subcarriers in the frequency domain and 14 OFDM symbols in the time domain. In the time domain, one downlink sub-frame is divided into two sections, namely a PDCCH region allocated with PDCCH and a PDSCH region allocated with PDSCH. The PDCCH region occupies maximally 3 OFDM symbols, counted from a first OFDM symbol, in a downlink sub-frame. Additionally, it is possible to allocate other downlink control channels, other than PDCCH, such as PCFICH (Physical Control Format Indicator Channel) and PHICH (Physical Hybrid automatic repeat request Indicator Channel) to the PDCCH region.

FIG. 7 shows an example of allocation of PDCCH resources in the PDCCH region. PDCCH resources are allocated in predetermined units called CCE (Control Channel Element). One CCE includes nine REG (Resource Element Group), wherein one REG includes four RE (Resource Element, i.e. a subcarrier).

As shown in FIG. 7, REG indexes are assigned in the time domain at first. The number of PDCCH resources allocated to one terminal device is set to 1, 2, 4, or 8 in CCE. The number of CCE indicates an aggregation level, wherein, at aggregation level 8, for example, the number of CCE allocated to one terminal device is set to 8. An aggregation of CCE indexes allocable to one terminal device in each sub-frame is univocally determined based on an index of each sub-frame and an identifier (or an index) identifying each terminal device. At aggregation level 4, for example, an aggregation of CCE indexes can be determined using two combinations, i.e. “12, 13, 14, 15” and “16, 17, 18, 19”.

PDCCH packets destined to a user terminal (UE) are produced by way of error correction coding, wherein their coding rates decrease as the number of CCE increases. When a PDCCH has a payload length of 47 bytes, for example, a coding rate is changed to ⅔, 2/6, 2/12, 2/24 as the number of CCE is changed to 1, 2, 4, 8. PDCCH packets constitute information representing allocation of PDSCH and PUSCH.

Since it is not notified which resources of the PDCCH region are allocated to PDCCH packets destined to a user terminal (UE), the user terminal performs blind decoding on all candidates allocated to the PDCCH region. The area subjected to blind decoding by the user terminal is called a search space, whose calculation is determined by a predetermined standard.

FIG. 8 is a block diagram diagrammatically showing a downlink control channel resource allocation system located in a base station device. The downlink control channel resource allocation system includes a correspondence storage unit 91, an aggregation level calculation unit 92, a PDCCH resource allocation control unit 93 a PDCCH information generation unit 94, a PDCCH resource allocation unit 95, and a wireless communication unit 96.

The correspondence storage unit 91 stores a CQI-to-aggregation level correspondence table in advance. The CQI-to-aggregation level correspondence table stores aggregation levels in correspondence with CQI values.

FIG. 9 shows an example of the CQI-to-aggregation level correspondence table, in which aggregation levels are correlated to CQI values. For instance, a CQI value “4” is correlated to an aggregation level “4”. In this connection, the correspondence between CQI values and aggregation levels has been determined by a predetermined standard in advance.

Referring back to FIG. 8, the aggregation level calculation unit 92 receives UE-CQI signals, which are fed back from a user terminal (UE), i.e. a destination of PDCCH packets, so that the aggregation level calculation unit 92 reads aggregation levels, corresponding to CQI values indicated by UE-CQI signals, from the correspondence storage unit 91, thus outputting UE aggregation levels to the PDCCH resource allocation control unit 93. Herein, UE-CQI signals indicate CQI values of terminal devices involving feedbacks of UE-CQI signals.

The PDCCH resource allocation control unit 93 receives UE aggregation levels output from the aggregation level calculation unit 92, sub-frame index signals representing indexes of sub-frames subjected to transmission, and UE index signals representing indexes identifying terminal devices.

Based on UE aggregation levels, sub-frame index signals, and UE index signals, the PDCCH resource allocation control unit 93 calculates allocated resource information, representing indexes of CCE allocated with PDCCH packets, with respect to each terminal device.

The PDCCH information generation unit 94 generates PDCCH packets representing PDSCH and/or PUSCH allocated to each terminal device. The PDCCH resource allocation unit 95 allocates PDCCH packets, which are generated by the PDCCH information generation unit 94, to CCE indicated by the allocated resource information calculated by the PDCCH resource allocation control unit 93, thus producing OFDM symbols in which transmission power of allocated PDCCH packets is set to a default value of PDCCH transmission power.

The wireless communication unit 96 transmits sub-frames including OFDM symbols produced by the PDCCH resource allocation unit 95.

The foregoing system is designed to calculate an aggregation level based on a UE-CQI signal received from a terminal device presently connected, thus allocating the number of CCE (i.e. a bandwidth) to a PDCCH resource based on the calculated aggregation level. Thus, PDCCH packets are arranged in the allocated PDCCH resource (CCE) and then subjected to transmission.

The 3GPP has actively studied heterogeneous networks (HetNet), which can rapidly expand communication areas with low cost. The heterogeneous network utilizes various local base station devices (or nodes), such as pico-base station devices and femto-base station devices, which consume small transmission power and which cover small communication areas, in addition to macro-base station devices which cover large communication areas, thus enlarging communication areas and improving communication quality.

Suppose that a macro-base station device (i.e. MeNB: Macro e-Node B) and a CSG (Closed-Subscriber Group) base station device utilize the same frequency range, wherein the CSG base station device is located in a predetermined communication area covered by the macro-base station device. Herein, the CSG base station device is regarded as a base station device facilitating communication with connection-permitted terminal devices alone. When a non-connection-permitted terminal device (or a non-CSG terminal device) is located close to the CSG base station device and inside the communication area of the CSG base station device, the CSG base station device does not accept a handoff request with respect to the non-CSG terminal device. In this case, the non-CGS terminal device fails to conduct handoff from the macro-base station device to the CSG base station device, so that the non-CSG terminal device will intensely interfere with radio waves emitted from the CSG base station device.

As described above, CCE allocated with PDCCH packets must be determined based on the index of a sub-frame and the index of a terminal device irrespective of an interference status. For this reason, when the non-CSG terminal device intensely interferes with the CSG base station device, the non-CSG terminal device may be unable to demodulate PDCCH packets transmitted thereto from the macro-base station device. Additionally, the non-CSG terminal device may be unable to demodulate traffic channels allocated to the PDSCH region. This situation leads to a communication breakdown with the non-CSG terminal device.

As described above, the LTE standard employs the OFDMA (Orthogonal Frequency Division Multiple Access) system as its downlink wireless access system, in which its system frequency range is divided into a plurality of subcarriers so that data channels are allocated to distinct terminal devices per subcarrier. Since the ODFMA system utilizes two-dimensional radio resources consisting of a frequency domain and a time domain, it is possible to flexibly allocate physical channels to terminal devices (see Non-Patent Documents 3, 4).

In the LTE downlink, channel quality measurement signals called RS (Reference Signal) are prerequisite for estimation of channel quality. In the LTE standard, allocation information of time-variant uplink/downlink data channels is notified to terminal devices by use of physical control channels called PDCCH (Physical Downlink Control Channel), which are used for notifying radio resource allocation information. In the LTE downlink, the number of OFDM symbols used by PDCCH is notified to terminal devices by use of physical control channels called PCFICH (Physical Control Format Indicator Channel), which are used for notifying information representing the number of OFDM symbols in PDCCH (i.e. information representing the number of OFDM symbols used in PDCCH). A downlink sub-frame of the LTE standard is constituted of (14 OFDM symbols)×(number of subcarriers in each frequency band); hence, a PDCCH region used for PDCCH allocation occupies maximally three OFDM symbols counted from the first OFDM symbol.

An arrangement of radio resources relating to RS, PCFICH, and PDCCH in the LTE downlink will be described with reference to FIG. 13, which illustrates RE and REG

### (a) Definition of REG (Resource Element Group)

The unit of REG is defined as 1 REG=1 OFDM symbol×4 Subcarriers. Herein, 1 REG=4 RE since the unit of RE (Resource Element) is defined as 1 RE=1 OFDM symbol×1 Subcarrier.

Each LTE downlink control channel occupies radio resources in units of REG. The following description refers to REG using coordinates of (x, y), where x denotes the lowest subcarrier (including the reference signal) in the REG, while y denotes an OFDM symbol ID.

### (b) Arrangement of RS Radio Resources

In the LTE downlink, RS radio resources are determined dependent upon the number of antenna ports. Specifically, RS radio resources are determined in accordance with Equation (1). FIG. 13 shows an arrangement of RS radio resources in a base station having two antennas with Cell ID=0.

$$\begin{matrix}k = 6 m + ( v + {v}_{shift} ) mod 6 & ( 1 ) \\ l = \{ \begin{matrix}0 , {N}_{symb}^{DL} - 3 & ifp ∈ \{ 0 , 1 \} \\ 1 & ifp ∈ \{ 2 , 3 \}\end{matrix} & \\ m = 0 , 1 , … , 2 \cdot {N}_{RB}^{DL} - 1 & \end{matrix}$$

In the above, k denotes a Subcarrier ID; 1 denotes an OFDM symbol ID in one slot (where 1 sub-frame=2 slots); p denotes an antenna port ID; N^{DL}_{symp} denotes the number of OFDM symbols (=7) included in one downlink slot; and N^{DL}_{RB} denotes the number of resource blocks included in a downlink band (e.g. N^{DL}_{RB}=50 in a frequency band of 10 MHz). Additionally, v and v_{shift} are expressed according to Equations (2) and (3).

$$\begin{matrix}v = \{ \begin{matrix}0 & ifp = 0 & and l = 0 \\ 3 & ifp = 0 & and l \neq 0 \\ 3 & ifp = 1 & and l = 0 \\ 0 & ifp = 1 & and l \neq 0 \\ 3 ( {n}_{s} mod 2 ) & ifp = 2 & \\ 3 + 3 ( {n}_{s} mod 2 ) & ifp = 3 & \end{matrix} & ( 2 ) \\ {v}_{shift} = {N}_{ID}^{cell} mod 6 & ( 3 )\end{matrix}$$

As shown in FIG. 13, maximally three patterns are set to RS arrangements according to Equations (1) to (3). This implies a probability in that an RS arrangement of one base station may overlap with an RS arrangement of its neighbor base station.

### (c) Arrangement of PCFICH Radio Resources

PCFICH radio resources are determined using 4 REG with OFDM symbol=0 in accordance with Equation (4).

k=mod( k̅,N_{RB}^{DL}N_{sc}^{RB}),

k=mod( k̅+└N_{RB}^{DL}/2┘·N_{sc}^{RB}/2,N_{RB}^{DL}N_{sc}^{RB}), (4)

k=mod( k̅+└2N_{RB}^{DL}/2┘·N_{sc}^{RB}/2,N_{RB}^{DL}N_{sc}^{RB}),

k=mod( k̅+└3N_{RB}^{DL}/2┘·N_{sc}^{RB}/2,N_{RB}^{DL}N_{sc}^{RB}),

where k̅=(N_{sc}^{RB}/2)·(N_{ID}^{cell} mod 2N_{RB}^{DL}), N_{sc}^{RB}=12.

In the multi-antenna system, each antenna port utilizes the same radio resource so as to transmit PCFICH by use of the transmission diversity mode of PCFICH. When cell ID=0, for example, 4 REG, i.e. (0,0), (150,0), (300,0), (450,0), are allocated to PCFICH. When cell ID=1, 4 REG, i.e. (6,0), (156,0), (306,0), (456,0), are allocated to PCFICH. When cell ID=25, 4 REG, i.e. (150,0), (300,0), (450,0), (0,0), are allocated to PCFICH.

### (d) Arrangement of PDCCH Radio Resources

Radio resources are utilized in units of CCE (Control Channel Element) with respect to PDCCH of each terminal device. The LTE specification describes that PDCCH is able to utilize radio resources of 1 CCE, 2 CCE, 4 CCE, or 8 CCE, wherein 1 CCE is constituted of 9 REG.

Mapping of REG constituting CCE is started from REG (0,0), wherein REG not allocated to other physical control channels are sequentially selected to constitute CCE in an order of incrementing y and then incrementing x.

Recently, engineers have come to notice technologies for improving radio quality in indoor/outdoor local areas (e.g. high-rise buildings, indoors of houses, and underground shopping centers), at which large-capacity traffic is concentrated, and technologies for alleviating traffic of conventional macro areas. These technologies achieve interpolation on macro areas by use of femto-base stations (which constitute femto-cells) whose transmission power is lower than transmission power of macro-base stations forming macro areas (which constitute macro-cells). FIG. 14 is a schematic diagram of a heterogeneous wireless access network constituted of macro-cells and femto-cells.

Femto-base stations can be classified into CSG (Closed Subscriber Group) femto-base stations and non-CSG femto-base stations. Only the registered terminal devices called “CSG terminal devices”, which are registered in advance with CSG femto-base stations, are allowed to access CSG femto-base stations, whilst unregistered terminal devices called “non-CSG terminal devices”, which are not registered with CSG femto-base stations, are not allowed to access CSG femto-base stations. That is, CSG femto-base stations are opened only when CSG terminal devices are located in their coverage areas (or femto-cells), whilst CSG femto-base stations are closed when non-CSG terminal devices are located in their coverage areas. On the other hand, non-CSG femto-base stations do not limit terminal devices which cause femto-base stations to open. In this connection, CSG femto-base stations are frequently utilized as femto-base stations installed in individual houses, because users may normally prefer to limit utilization by other persons by way of security settings in WiFi environments. Hereinafter, CSG femto-base stations will be simply referred to as CSG base stations.

CSG base stations are used to expand communication areas, whereas CSG base stations may intensely interfere with non-CSG terminal devices (which are not registered with CSG base stations but located in coverage areas of CSG base stations) so as to degrade their reception power of physical control channels. When an unregistered terminal device (e.g. a non-CSG terminal device) is located in the coverage area of a small-scale base station (e.g. a CSG base station) facilitating communication with a registered terminal device (e.g. a CSG terminal device), there is a problem in that reception quality of a physical control channel of the unregistered terminal device must be degraded due to intense interference with the small-scale base station.

Specifically, the following problems occur in connection with RS, PCFICH, PDCCCH radio resources.

### (i) Influence and Degradation of RS Reception Quality

When a non-CSG terminal device, which is not permitted to access a CSG base station, approaches the CSG base station, the non-CSG terminal device is unable to perform RS reception with a macro-base station due to intense interference with the CSG base station. This may lead to frequent occurrence of radio link failure.

### (ii) Influence and Degradation of PCFICH Reception Quality

When a non-CSG terminal approaches a CSG base station, the non-CSG terminal device is unable to perform PCFICH reception with a macro-base station due to intense interference with the CSG base station. This may prevent decoding of allocated information.

(iii) Influence and Degradation of PDCCH Reception Quality

When a non-CSG terminal device approaches a CSG base station, the non-CSG terminal device is unable to perform PDCCH reception with a macro-base station due to intense interference with the CSG base station. This may prevent decoding of allocated information.

As described above, various standardization organizations, namely the 3GPP (3rd Generation Partnership Project), 3GPP2 (3rd Generation Partnership Project 2), and IEEE802.16, have been studying standardization on successors to third-generation (3G) cellular systems, namely next generation cellular systems (called 3.9G cellular system) such as LTE (Long Term Evolution, or E-UTRA: Evolved Universal Terrestrial Radio Access) and UMB (Ultra Mobile Broadband), and advanced 3.9G cellular system such as IMT-Advanced system (called 4G cellular system).

All the LTE, UMB, WiMAX systems and the 4G cellular systems such as LTE-Advanced and IEEE802.16m adopt the OFDMA (Orthogonal Frequency Division Multiple Access) system. A wireless communication system employing OFDMA (hereinafter, referred to as an OFDMA system) is able to allocate a plurality of subcarriers, included in its system frequency range, to mobile terminal devices, wherein allocated subcarriers can be arbitrarily changed in both the frequency domain and the time domain. Generally speaking, this OFDMA system is able to flexibly perform radio resource allocation using two-dimensional radio resources defined in the frequency domain and the time domain.

Mobile terminal devices undergo fluctuations of frequency resources having good communication quality under frequency-selective phasing environments; hence, frequency scheduling is needed to allocate frequency resources having good communication quality to mobile terminal devices. The frequency scheduling improves throughputs of mobile terminal devices, thus improving the overall throughput in wireless communication systems. Normally, communication quality of frequency resources is measured using a reference signal (RS) included in frequency resources. For this reason, the frequency scheduling needs to obtain communication quality per each frequency resource in the entire frequency range of the OFDMA system.

In the downlink communication from a base station device to a mobile terminal device, the base station device transmits data to the mobile terminal device by use of frequency resources each embedding a reference signal, which the base station device allocates to the mobile terminal device. This reference signal is already known by all mobile terminal devices. For this reason, another mobile terminal device, which is not allocated with a frequency resource block embedding a reference signal, is able to demodulate the reference signal so as to measure communication quality of the frequency resource block.

In the uplink communication from a mobile terminal device to a base station device, the base station device is unable to obtain communication quality of other frequency resources other than frequency resources which the base station device receives from the mobile terminal device if frequency resources which the base station device allocates to the mobile terminal device do not constitute the entire frequency range of the wireless communication system.

To cope with this drawback, Non-Patent Document 1 defines another reference signal called a sounding reference signal (SRS) in the uplink communication. This SRS can be transmitted maximally in the entire frequency range of the wireless communication system; this makes it possible to obtain uplink frequency characteristics (i.e. communication quality per each frequency resource). However, Non-Patent Document 1 reveals a certain limitation in radio resources used for transmitting sounding reference signals (SRS) (hereinafter, referred to as SRS radio resources), whereby mobile terminal devices interfere with each other when all mobile terminal devices normally transmit sounding reference signals (SRS) so that mobile terminal devices cannot properly demodulate sounding reference signals (SRS); hence, it is difficult to obtain frequency characteristics.

To cope with this drawback, Non-Patent Document 2 discloses that mobile terminal devices are allowed to use fixed SRS radio resources. Specifically, parameters of SRS radio resources are determined not to exceed the total number of SRS radio resources. Based on the presupposition that the number of mobile terminal devices is fixed for the purpose of performance evaluation, it is presumed that SRS radio resources allocated to mobile terminal devices are fixed (or unchanged).

Due to tightness of SRS radio resources, it becomes very difficult to allocate SRS radio resources to mobile terminal devices newly visiting cells since the increasing number of mobile terminal devices has currently visited cells. Unless SRS radio resources are allocated to mobile terminal devices, it is impossible to measure frequency characteristics of mobile terminal devices. This prevents frequency scheduling, which is an important feature of the OFDMA system, and increases probability of causing degradation of throughput.

As a result, the conventional technologies are unable to demonstrate adequate communication quality in mobile terminal devices unless SRS radio resources are appropriately allocated to mobile terminal devices newly connected to base station devices due to tightness of SRS radio resources.

The following documents are listed as exemplary background arts illustrating technical fields of the present invention.
Non-Patent Document 1: 3GPP, TS 36.211 V8.8.0, “3rd Generation Partnership Project; Technical Specification Group Radio Access Network; Evolved Universal Terrestrial Radio Access (E-UTRA); Physical Channels and Modulation (Release 8)”, September 2009
Non-Patent Document 2: 3GPP, TS 36.213 V8.8.0, “3rd Generation Partnership Project; Technical Specification Group Radio Access Network; Evolved Universal Terrestrial Radio Access (E-UTRA); Physical layer procedures (Release 8)”, September 2009
Non-Patent Document 3: 3GPP, TS 36.211 V9.1.0, “3rd Generation Partnership Project; Technical Specification Group Radio Access Network; Evolved Universal Terrestrial Radio Access (E-UTRA); Physical Channels and Modulation (Release 9)”, March 2010
Non-Patent Document 4: TS 36.213 V9.1.0, “3rd Generation Partnership Project; Technical Specification Group Radio Access Network; Evolved Universal Terrestrial Radio Access (E-UTRA); Physical layer procedures (Release 9)”, March 2010
Non-Patent Document 5: Kenta OKINO, Yoshimasa KUSANO, “A study on SRS parameter configuration in consideration of channel estimation error for E-UTRA uplink”, IEICE Technical Report, RCS2008-245, March 2009
Non-Patent Document 6: 3GPP TS 36.331 V8.9.0, “3rd Generation Partnership Project; Technical Specification Group Radio Access Network; Evolved Universal Terrestrial Radio Access (E-UTRA): Radio Resource Control (RRC) Protocol specification (Release 8)”, March 2010

### SUMMARY OF THE INVENTION

The present invention seeks to solve the problems, or to improve upon the problems at least in part.

It is an object of the present invention to provide a wireless communication system, a base station device, and a program, which prevent a non-connection-permitted terminal device, approaching a predetermined base station device, from interfering with the base station due to failure of handoff, wherein it is possible to reduce interference affecting a control signal forwarded to the non-connection-permitted terminal device from another base station device.

It is another object of the present invention to provide a base station device ensuring an adequate quality of communication even when an unregistered terminal device (e.g. a non-CSG terminal device) is located in the coverage area of a small-scale base station (e.g. a CSG base station) facilitating communication with a registered terminal device (e.g. a CSG terminal device), wherein it is possible to prevent or reduce degradation of reception quality via a physical control channel of the unregistered terminal device.

It is a further object of the present invention to provide a base station device, a frequency band allocation method and a program, ensuring appropriate allocation of SRS radio resources to newly connected mobile terminal devices irrespective of tightness of SRS radio resources.

In a first aspect of the invention, a wireless communication system includes a first base station device, a second base station device, a first terminal device having a connection permission with the first base station device, and a second terminal device which does not have the connection permission with the first base station device but which is connectible to the second base station device by use of the same frequency range as the frequency range by which the first terminal device is connected to the first base station device.

In the first base station device, a decision is made as to whether or not the second terminal device is located in a communication area of the first base station device; a first frequency band, depending upon a radio quality of communication conducted between the first terminal device and the first base station device, is allocated to the first terminal device when the second terminal device is not located in the communication area, whilst a narrow frequency band, narrower than the first frequency band, is allocated to the first terminal device when the second terminal device is located in the communication area; and a control signal, representing allocation of a traffic channel, is transmitted to the first terminal device by use of the first frequency band or the narrow frequency band which the first allocation control unit allocates to the first terminal device.

The first base station device further includes a correspondence table that stores the radio quality of communication, conducted between the first terminal device and the first base station device, in connection with an SINR (Signal to Interference and Noise Ratio) value satisfying the radio quality of communication. Additionally, the control signal is transmitted to the first terminal device with a default value of transmission power when the second terminal device is not located in the communication area of the first base station device. When the second terminal device is located in the communication area, a target SINR value, corresponding to a target radio quality of communication, and a current SINR value, corresponding to the radio quality of communication currently established with the first terminal device, are read from the correspondence table; the default value of transmission power is modified based on a bias value, corresponding to a difference between the target SINR value and the current SINR value, so that the modified default value of transmission power is adopted in transmitting the control signal to the first terminal device.

In the second base station device, a decision is made as to whether or not the second terminal device, which is connected to the second base station device, is located in the communication area of the first base station device. Additionally, a second frequency band, depending upon a radio quality of communication conducted between the second terminal device and the second base station device, is allocated to the second terminal device when the second terminal device is not located in the communication area, whilst a broad frequency band, broader than the second frequency band, is allocated to the second terminal device when the second terminal device is located in the communication area. The control signal is transmitted to the second terminal device by use of the second frequency band or the broad frequency band which is allocated to the second terminal device.

The second base station device is able to transmit a handoff request, establishing a connection with the second terminal device, to the first base station device so that the first base station device accepts or declines the handoff request by sending back a message to the second base station device. Additionally, the second base station device detects the number of messages declining handoff requests in a predetermined preceding time period. It is determined that the second terminal device is located in the communication area of the first base station device when the detected number of message declining handoff requests is equal to or above a predetermined threshold, whilst it is determined that the second terminal device is not located in the communication area when the detected number of messages declining handoff requests is less than the predetermined threshold.

On the other hand, the first base station device is able to receive the handoff request, establishing the connection with the second terminal device, so as to send back the message declining the handoff request to the second base station device. Additionally, the first base station device detects the number of messages declining handoff requests in a predetermined preceding time period. It is determined that the second terminal device is located in the communication area of the first base station device when the detected number of messages declining handoff requests is equal to or above a predetermined threshold, whilst it is determined that the second terminal device is not located in the communication area when the detected number of messages declining handoff requests is less than the predetermined threshold.

A wireless communication method is adapted to the wireless communication system, wherein a decision is made, by the first base station device, as to whether or not the second terminal device is located in the communication area of the first base station device; the first frequency band, depending upon the radio quality of communication conducted between the first terminal device and the first base station device, is allocated to the first terminal device when the second terminal device is not located in the communication area, whilst a narrow frequency band, narrower than the first frequency band, is allocated to the first terminal device when the second terminal device is located in the communication area; and a control signal, representing allocation of a traffic channel, is transmitted to the first terminal device by use of the first frequency band or the narrow frequency band which is allocated to the first terminal device.

Furthermore, a program is provided to cause a computer to implement the wireless communication method adapted to the wireless communication system.

In a second aspect of the invention, a base station device (e.g. a CSG base station device), which is able to communicate with a registered terminal device (e.g. a CSG terminal device) except for an unregistered terminal device (e.g. a non-CSG terminal device), includes an unregistered terminal device decision unit that makes a decision as to whether or not the unregistered terminal device exists in the coverage area, an antenna transmission mode determination unit that determines an antenna transmission mode based on the decision result of the unregistered terminal device decision unit; a scheduler mode determination unit that determines a scheduler mode based on the decision result of the unregistered terminal device decision unit; and an OFDM symbol determination unit that determines the number of OFDM symbols, which a physical control channel (PDCCH) utilizes to notify radio resource allocation information, based on the decision result of the unregistered terminal device decision unit.

In the above, the antenna transmission mode determination unit determines the antenna transmission mode based on the number of embedded antennas, embedded in the base station device, when the unregistered terminal device decision unit determines that the unregistered terminal device does not exist in the coverage area, whilst the antenna transmission mode determination unit determines the antenna transmission mode based on existence or nonexistence of antenna information regarding the number of antennas installed in a secondary base station device (e.g. a macro-base station device) which the unregistered terminal device communicates with when the unregistered terminal device decision unit determines that the unregistered terminal device exists in the coverage area.

When the unregistered terminal device decision unit determines that the unregistered terminal device exists in the coverage area, the antenna transmission mode determination unit selects a single antenna transmission mode owing to nonexistence of the antenna information, whilst the antenna transmission mode determination unit determines the antenna transmission mode based on the relationship between the number of embedded antennas and the number of antennas installed in the secondary base station device owing to existence of the antenna information.

The antenna transmission mode determination unit determines the single antenna transmission mode with a desired antenna port indicating a higher average value of Wideband CQI (Wideband Channel Quality) fed back thereto.

The scheduler mode determination unit selects a dynamic scheduler mode when the unregistered terminal device decision unit determines that the unregistered terminal device does not exist in the coverage area, whilst the scheduler mode determination unit selects a semi-persistent scheduler mode when the unregistered terminal device decision unit determines that the unregistered terminal device exists in the coverage area.

After selecting the semi-persistent scheduler mode, the scheduler mode determination unit changes the semi-persistent scheduler mode with the dynamic scheduler mode periodically or in an event-driven manner.

The OFDM symbol determination unit sets a non-zero number to the number of OFDM symbols when the unregistered terminal device decision unit determines that the unregistered terminal device does not exist in the coverage area, whilst the OFDM symbol determination unit sets zero to the number of OFDM symbols when the unregistered terminal device decision unit determines that the unregistered terminal device exists in the coverage area. In this connection, the OFDM symbol determination unit changes the number of OFDM symbols from zero to a non-zero number periodically or in an event-driven manner.

Furthermore, it is possible to provide a program causing a computer to implement the functionality of the foregoing base station device.

In a third aspect of the invention, a base station device includes a transmission scheduling table that stores allocation information of radio resources representing frequencies and bandwidths used for transmission of sounding reference signals (SRS) with regard to mobile terminal devices; a divisible radio resource determination unit that makes a decision as to whether or not a selected mobile terminal device is allocable with a combination of divisible radio resources with a divisible bandwidth with reference to the transmission scheduling table; a divisible radio resource dividing unit that divides the divisible bandwidth of the combination of divisible radio resources allocated to the selected mobile terminal device, thus producing a vacancy of radio resources; and a radio resource allocation unit that allocates the vacancy of radio resources to another mobile terminal device.

The base station device further includes a minimum bandwidth determination unit that determines a minimum value of a bandwidth with regard to each combination of radio resources based on mobility of each mobile terminal device. The divisible radio resource determination unit determines the selected mobile terminal device to be allocated with the combination of divisible radio resources with the divisible bandwidth which is larger than the minimum value of the bandwidth determined by the minimum bandwidth determination unit, so that the radio resource dividing unit reduces the divisible bandwidth of the combination of divisible radio resources allocated to the selected mobile terminal device.

In the above, the divisible radio resource determination unit selects one of plural combinations of divisible radio resources with divisible bandwidths such that the selected combination of divisible radio resources is allocable to the minimum number of mobile terminal devices. Alternatively, the divisible radio resource determination unit selects one of plural combinations of divisible radio resources with divisible bandwidths such that the divisible bandwidth in the selected combination of radio resources is minimum or maximum. The radio resource allocation unit allocates the vacancy of radio resources to transmission of sounding reference signals (SRS).

A band allocation method adapted to a base station device having a transmission scheduling table implements a decision step of making a decision as to whether or not a selected mobile terminal device is allocable with a combination of divisible radio resources with a divisible bandwidth with reference to the transmission scheduling table; a dividing step of dividing the divisible bandwidth of the combination of divisible radio resources allocated to the selected mobile terminal device, thus producing a vacancy of radio resources; and an allocating step of allocating the vacancy of radio resources to another mobile terminal device.

A program causes a computer of a base station device to implement a band allocation method including the decision step, dividing step, and allocating step as well as a storing step of storing allocation information of radio resources with regard to mobile terminal devices in the transmission scheduling table.

As described above, the present invention demonstrates outstanding effects as follows.

The present invention is able to reduce interference with a terminal device having connection permission when another terminal device having no connection permission approaches a base station device.

The present invention is able to prevent or reduce degradation of reception quality via a physical control channel of an unregistered terminal device (e.g. a non-CSG terminal device) when the unregistered terminal device is located in the coverage area of a small-scale base station (e.g. a CSG base station) facilitating communication with a registered terminal device (e.g. a CSG terminal device).

The present invention is able to prevent or reduce degradation of reception quality with a physical control channel (PDCCH) of an unregistered terminal device (e.g. a non-CSG terminal device), which exists in the coverage area of a small-scale base station device (e.g. a CSG base station device) facilitating communication with a registered terminal device (e.g. a CSG terminal device).

The present invention is able to reduce bandwidths of already allocated radio resources irrespective of tightness of radio resources, thus producing a vacancy of radio resources. This makes it possible to allocate an appropriate combination of radio resources to a mobile terminal device newly connected with the base station device, ensuring transmission of sounding reference signals (SRS). Thus, it is possible to implement frequency scheduling reflecting frequency characteristics of a newly connected mobile terminal device, thus improving throughputs of mobile terminal devices and communication capacity of the OFDMA system.

### BRIEF DESCRIPTION OF THE DRAWINGS

These and other objects, aspects, and embodiments of the present invention will be described in more detail with reference to the following drawings.

FIG. 1 is a schematic diagram of a wireless communication system according to a first embodiment of the present invention.

FIG. 2 is a block diagram of a CSG base station device included in the wireless communication system.

FIG. 3 shows an example of a correspondence table depicting the relationship between CQI values, aggregation levels, and SINR values.

FIG. 4 is a block diagram of a macro-base station device included in the wireless communication device.

FIG. 5 is a sequence diagram illustrating processing of the wireless communication system.

FIG. 6 shows a downlink sub-frame configuration at a system band of 10 MHz.

FIG. 7 shows an example of PDCCH resource allocation in a PDCCH region of a downlink sub-frame.

FIG. 8 is a block diagram of a downlink control channel resource allocation system in a base station device.

FIG. 9 shows an example of a CQI-to-aggregation level correspondence table.

FIG. 10 is a block diagram of a CSG base station device according to a second embodiment of the present invention.

FIG. 11 is a schematic diagram of a wireless communication system including a macro-base station, a CSG base station, and a non-CSG terminal device.

FIG. 12A is a flowchart showing the operation of the CSG base station device.

FIG. 12B is a flowchart showing the details of step S150 shown in FIG. 12A.

FIG. 13 shows an arrangement of REG and RS radio resources in a two-dimensional space consisting of subcarriers and OFDM symbols.

FIG. 14 is a schematic diagram of a heterogeneous wireless access network constituted of macro-cells and femto-cells.

FIG. 15 is a block diagram of an OFDMA system according to a third embodiment of the present invention.

FIG. 16 shows a partial configuration of uplink radio resources in the OFDMA system.

FIG. 17 is a block diagram showing the details of an SRS transmission scheduling unit and an SRS band dividing unit included in the OFDMA system shown in FIG. 15.

FIG. 18 shows an example of a permissible mobility determination table included in the SRS transmission scheduling unit shown in FIG. 17.

FIG. 19 shows an example of an SRS transmission scheduling table included in the SRS transmission scheduling unit shown in FIG. 17.

FIG. 20 shows an example of a partial table included in the SRS transmission scheduling table shown in FIG. 19.

FIG. 21 shows an example of a correspondence relationship between an SRS bandwidth (M_SRS) and an SRS band offset number (j_SRS).

FIG. 22 is a flowchart showing a procedure of SRS transmission scheduling.

FIG. 23 is a flowchart showing a procedure of SRS transmission scheduling.

FIG. 24 is a flowchart showing the details of steps S600 and S650 shown in FIG. 23.

FIG. 25 is a flowchart showing a procedure of SRS transmission scheduling.

### DESCRIPTION OF THE PREFERRED EMBODIMENTS

The present invention will be described in further detail by way of examples with reference to the accompanying drawings.

### 1. First Embodiment

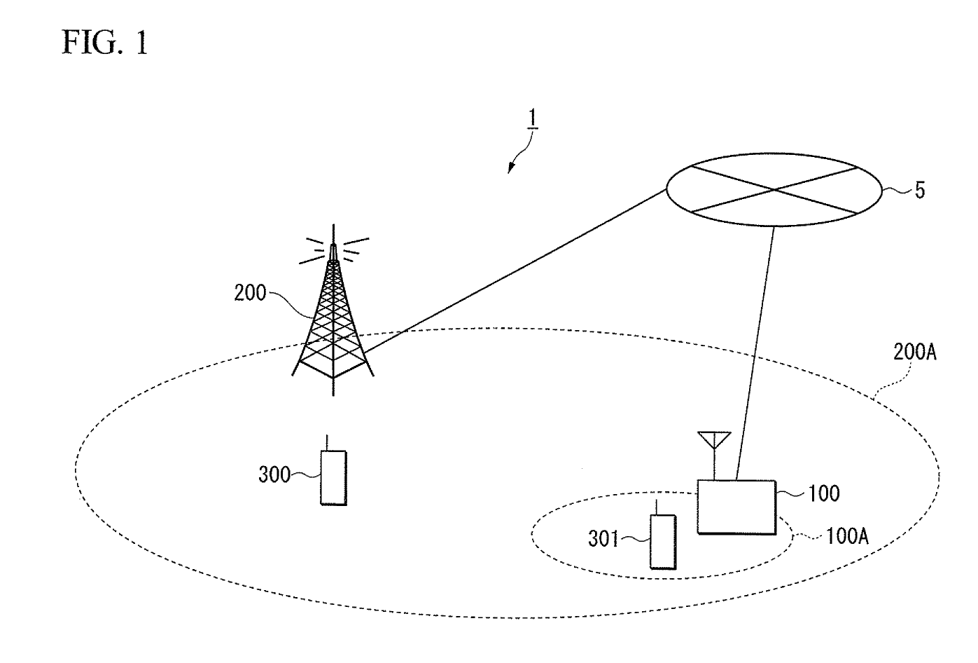

FIG. 1 is a schematic diagram of a wireless communication system 1 according to a first embodiment of the present invention. The wireless communication system 1 conducts communication according to a communication system prescribed by the LTE standard. The wireless communication system 1 includes a non-CSG terminal device 300 (where “CSG” stands for “Closed Subscriber Group”), a CSG terminal device 301, a macro-base station device 200 which conducts communication with the non-CSG terminal device 300 and the CSG terminal device 301 via communication links, a CSG base station device 100 which communicates with the CSG terminal device 301, and a network 5 which connects the CSG base station device 100 and the macro-base station device 200 via wires.

The CSG base station device 100 and the macro-base station device 200 cover communication areas 100A and 200A encompassed using broken lines. The CSG base station device 100 is located inside the communication area 200A of the macro-base station device 200. The CSG base station device 100 communicates with the CSG terminal device 301 by use of the same frequency range as the frequency range which the macro-base station device 200 utilizes in communication with the non-CSG terminal device 300 and the CSG terminal device 301. For instance, the CSG base station device 100 is either a pico-base station device or a femto-base station device, which consumes a small transmission power and which covers a small communication area. Additionally, the macro-base station device 200 is a macro base station which covers a large communication area.

The non-CSG terminal device 300 is able to communicate with other terminal devices when connected with the macro-base station device 200. In this connection, the non-CSG terminal device 300 is regarded as a terminal device which is not permitted to be connected to the CSG base station device 100.

The CSG terminal device 301 is able to communicate with other terminal devices when connected with the CSG base station device 100 or the macro-base station device 200. The CSG terminal device 301 differs from the non-CSG terminal device 300 in that it is permitted to be connected to the CSG base station device 100.

Next, a specific scheme and processing for reducing interference that the non-CSG terminal device 300 undergoes by the CSG base station device 100 when the non-CSG terminal device 300, currently connected with the macro-base station device 200, approaches the CSG base station device 100 will be described.

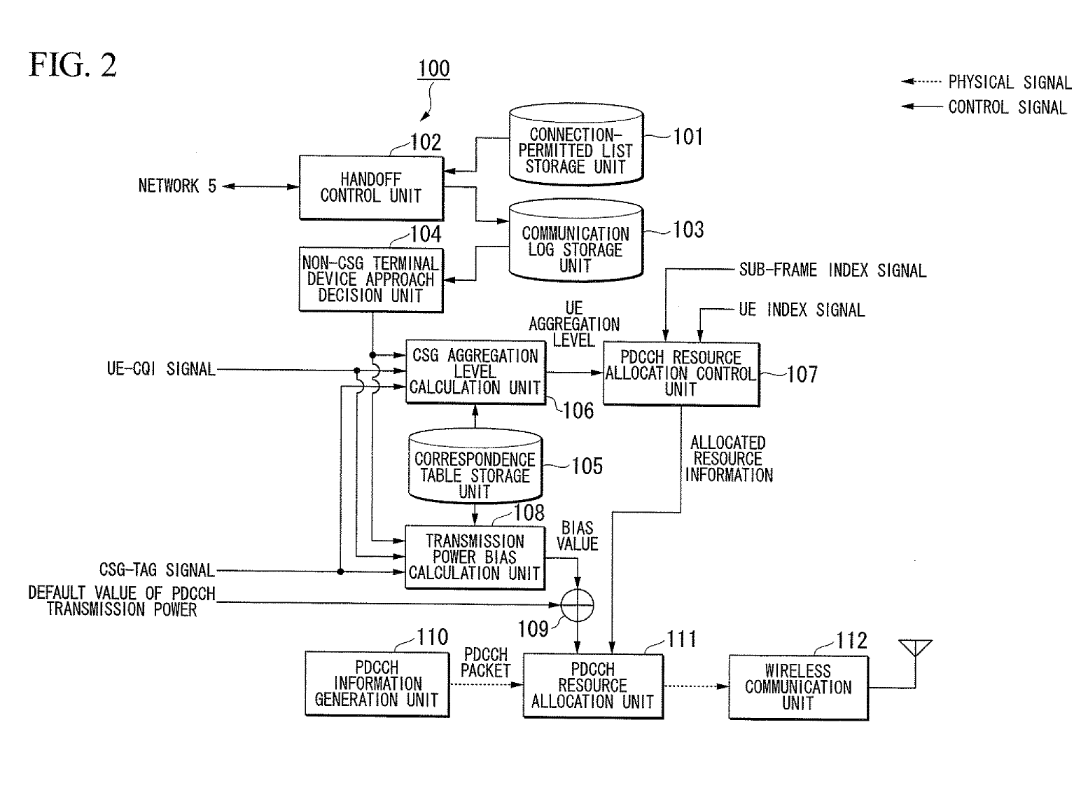

FIG. 2 is a block diagram of the CSG base station device 100 included in the wireless communication system 1. The CSG base station device 100 includes a connection-permitted list storage unit 101, a handoff control unit 102, a communication log storage unit 103, a non-CSG terminal device approach decision unit 104, a correspondence table storage unit 105, a CSG aggregation level calculation unit 106, a PDCCH resource allocation control unit 107, a transmission power bias calculation unit 108, an adder 109, a PDCCH information generation unit 110, a PDCCH resource allocation unit 111, and a wireless communication unit 112.

The connection-permitted list storage unit 101 stores indexes of terminal devices which are permitted to be connected to the CSG base station device 100 by itself in advance. Herein, indexes are identifiers which are assigned to terminal devices in advance so as to univocally identify terminal devices.

The handoff control unit 102 receives a message, which includes an index of a specific terminal device and its handoff request (HO (Handoff) Request) to the CSG base station device 100, from another terminal device so as to make a decision as to whether or not the index included in the received message is stored in the connection-permitted list storage unit 101.

When an index of a terminal device is stored in the connection-permitted list storage unit 101, the handoff control unit 102 sends back a message, indicating that the CSG base station device 100 accepts a handoff request thereto, to a source of making such a handoff request via the network 5. When an index of a terminal device is not stored in the connection-permitted list storage unit 101, the handoff control unit 102 sends back a message (HO Preparation Failure), indicating that the CSG base station device 100 declines a handoff request thereto, to a source of making such a handoff request. Additionally, the handoff control unit 102 stores these messages in the communication log storage unit 103. The communication log storage unit 103 stores messages sent by the handoff control unit 102.

The non-CSG terminal device approach decision unit 104 makes a decision, based on a history of messages stored in the communication log storage unit 103, as to whether or not the non-CSG terminal device 300, which is not permitted to be connected to the CSG base station device 100, approaches the CSG base station device 100.

An event in which the non-CSG terminal device 300 approaches the CSG base station device 100 is regarded as the timing when the non-CSG terminal device 300 is located inside the communication area 100A where a reception power by which the CSG terminal device 300 receives signals from the CSG base station device 100 becomes higher than a reception power by which the CSG terminal device 300 receives signals from another base station device. In other words, this event occurs when the non-CSG terminal device 300 is located inside the communication area 100A covered by the CSG base station device 100.

The non-CSG terminal device approach decision unit 104 makes a decision as to whether or not the non-CSG terminal device 300, which is not permitted to be connected to the CSG base station device 100, approaches the CSG base station device 100 in accordance with the following procedure.

The non-CSG terminal device approach decision unit 104 detects the number of messages declining handoff requests, which are transmitted during a predetermined preceding time period, among messages stored in the communication log storage unit 103, thus making a decision as to whether or not the detected number of messages is equal to or above a predetermined threshold. When the detected number of messages is equal to or above the threshold, the non-CSG terminal device approach decision unit 104 determines that the non-CSG terminal device 300 approaches the CSG base station device 100. In contrast, when the detected number of messages is less than the threshold, the non-CSG terminal device approach decision unit 104 determines that the non-CSG terminal device 104 does not approach the CSG base station device 100, i.e. it determines that the non-CSG terminal device 300 is distanced from the CSG base station device 100.

The correspondence table storage unit 105 stores a correspondence table, indicating the relationship between CQI (Channel Quality Indicator) values, aggregation levels, and SINR (Signal to Interference and Noise Ratio) values, in advance. This correspondence table indicates correspondence between a desired SINR value and an aggregation level per each CQI value. Incidentally, the foregoing standard has prescribed the correspondence between desired SINR values and aggregation levels in connection with CQI values.

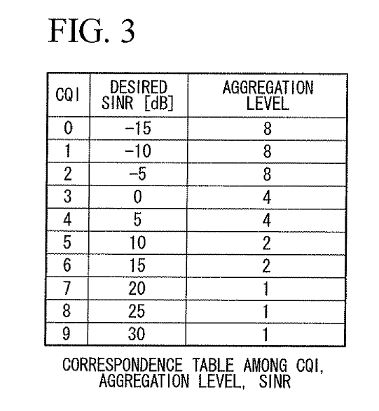

FIG. 3 shows an example of the correspondence table indicating the relationship between CQI values, aggregation levels, and SINR values. The sheet of the correspondence table of FIG. 3 is subdivided into three items, namely CQI values, desired SINR values, and aggregation levels. Each row of the correspondence table records a pair of a desired SINR value and an aggregation level per each CQI value. The value of CQI is an indicator of radio quality per each reception channel and is connected with a desired value of SINR and an aggregation level. The desired value of SINR is needed to satisfy the corresponding CQI value. For instance, a CQI value “5” is connected to a desired SINR value “10 [dB]” and an aggregation level “2”.

Referring back to FIG. 2, the CSG aggregation level calculation unit 106 receives a UE-CQI signal representing a CQI value fed back from the CSG terminal device 301 (which is currently connected to the CSG base station device 100), a CSG target aggregation level signal (i.e. a CSG-TAG signal), and a decision result of the non-CSG terminal device approach decision unit 104. Based on the UE-CQI signal, CSG-TAG signal, and the decision result, the CSG aggregation level calculation unit 106 calculates an aggregation level (i.e. a UE-aggregation level) with respect to the CSG terminal device 301 feeding back the UE-CQI signal.

The CSG-TAG signal indicates an aggregation level applied to the CSG terminal device 301 (which is presently connected to the CSG base station device 100) when the non-CSG terminal device 300 approaches the CSG base station device 100. The aggregation level of the CSG-TAG signal is determined through simulation or measurement, wherein this aggregation level is smaller than an average value of aggregation levels applied to the CSG terminal device 301. When an average value of aggregation levels is “4”, for example, the target aggregation level is set to “1” or “2”. In this connection, it is possible to set the minimum aggregation level to the target aggregation level.

Specifically, when the non-CSG terminal device approach decision unit 104 determines that the non-CSG terminal device 300 approaches the CSG base station device 100, the CSG aggregation level calculation unit 106 outputs the aggregation level of the CSG-TAG signal as the UE aggregation level. In contrast, when the non-CSG terminal device approach decision unit 104 determines that the non-CSG terminal device 300 does not approach the CSG base station device 100, the CSG aggregation level calculation unit 106 reads an aggregation level, corresponding to a CQI value of the UE-CQI signal, from the correspondence table storage unit 105, thus outputting the read aggregation level as the UE aggregation level.

The PDCCH resource allocation control unit 107 receives the UE aggregation level calculated by the CSG aggregation level calculation unit 106, a sub-frame index signal representing an index of a transmitting sub-frame, and a UE index signal representing an index identifying the CSG terminal device 301 which is allocated with PDCCH resource. Based on the UE aggregation level, the sub-frame index signal, and the UE index signal, the PDCCH resource allocation control unit 107 selects an appropriate value of CCE allocated to the CSG terminal device 301, thus outputting allocated resource information indicating the selected CCE. The CCE is allocated according to a specific allocation method prescribed in the foregoing standard.

The transmission power bias calculation unit 108 receives the UE-CQI signal, the CSG-TAG signal, and the decision result of the non-CSG terminal device approach decision unit 104. Based on the UE-CQI signal, the CSG-TAG signal, and the decision result, the transmission power bias calculation unit 108 calculates a bias value applied to transmission power of PDCCH packets toward the CSG terminal device 301 with reference to the correspondence table, indicating the relationship between CQI values, aggregation levels, and SINR values, stored in the correspondence table storage unit 105.

Specifically, when the non-CSG terminal device approach decision unit 104 determines that the non-CSG terminal device 300 approaches the CSG base station device 100, the transmission power bias calculation unit 108 calculates a bias value per each CCE in accordance with Equation (5). In contrast, when the non-CSG terminal device approach decision unit 104 determines that the non-CSG terminal device 300 does not approach the CSG base station device 100, the transmission power bias calculation unit 108 outputs a bias value of 0 dB.

Bias value=min(f2(CSG−TAG)−f1(UE−CQI)) (5)

In Equation (5), “CSG-TAG” denotes the aggregation value of the CSG-TAG signal, whilst “UE-CQI” denotes the CQI value of the UE-CQI signal. Function f1( ) produces a series SINR value satisfying the CQI value, whilst function f2( ) produces a desired SINR value based on the aggregation level. Function min( ) selects a minimum value among values in parenthesis. These functions f1( ), f2( ) are made based on the relationship between CQI values, aggregation levels, and SINR values described in the correspondence table stored in the correspondence table storage unit 105.

The transmission power bias calculation unit 108 reads a desired SINR value (i.e. a present power ratio), corresponding to the UE-CQI signal, from the correspondence table storage unit 105. Additionally, the transmission power bias calculation unit 108 reads a minimum SINR value (i.e. a target power ratio), among desired SINR values corresponding to the aggregation level of the CSG-TAG signal, from the correspondence table storage unit 105. Subsequently, the transmission power bias calculation unit 108 subtracts the desired SINR value corresponding to the UE-CQI signal from the desired SINR value corresponding to the CSG-TAG signal, thus producing a bias value.

When the UE-CQI signal indicates a CQI value “2” whilst the CSG-TAG signal indicates an aggregation level “1”, for example, the transmission power bias calculation unit 108 calculates a bias value in accordance with the following procedure.

With reference to the correspondence table of FIG. 3 indicating the relationship between CQI value, aggregation levels, and SINR values, a desired SINR value “−5 dB” is read out in correspondence with the UE-CQI signal. The CSG-TAG signal corresponds to desired SINR values of “20 dB”, “25 dB”, and “30 dB”, among which the minimum SINR value of “20 dB” is selectively read out in correspondence with the CSG-TAG signal. As a result, the transmission power bias calculation unit 108 produces a bias value of “20 dB−(−5 dB)=25 dB”.

The adder 109 adds the default value of PDCCH transmission power to the bias value calculated by the transmission power bias calculation unit 108, thus outputting the addition result as UE-PDCCH transmission power. The PDCCH information generation unit 110 generates PDCCH packets indicating PDSCH and/or PUSCH allocated to the CSC terminal device 301. That is, the PDCCH information generation unit 110 generates PDCCH packets (or control signals) representing allocation of traffic channels. The default value of PDCCH transmission power denotes a power value per each subcarrier, which is prescribed by the foregoing standard.

The transmission power bias calculation unit 108 coupled with the adder 109 operates in such a way that, when the non-CSG terminal device 300 approaches the CSG base station device 100, the target transmission power ratio (i.e. the desired SINR value corresponding to the CSG-TAG signal) and the current power ratio (i.e. the desired SINR value corresponding to the CQI value currently applied to the CSG terminal device 301) are read from the correspondence table storage unit 105; the bias value is produced by subtracting the current power ratio from the target power ratio; then, the default value of PDCCH transmission power is modified based on the bias value, thus determining transmission power.

The PDCCH resource allocation unit 111 allocates PDCCH packets, which are generated by the PDCCH information generation unit 110, to CCE indicated by the allocated resource information output from the PDCCH resource allocation control unit 107. Additionally, the PDCCH resource allocation unit 111 produces OFDM symbols such that transmission power of PDCCH packets matches with UE-PDCCH transmission power output from the adder 109. The wireless communication unit 112 transmits a sub-frame including OFDM symbols produced by the PDCCH resource allocation unit 111.

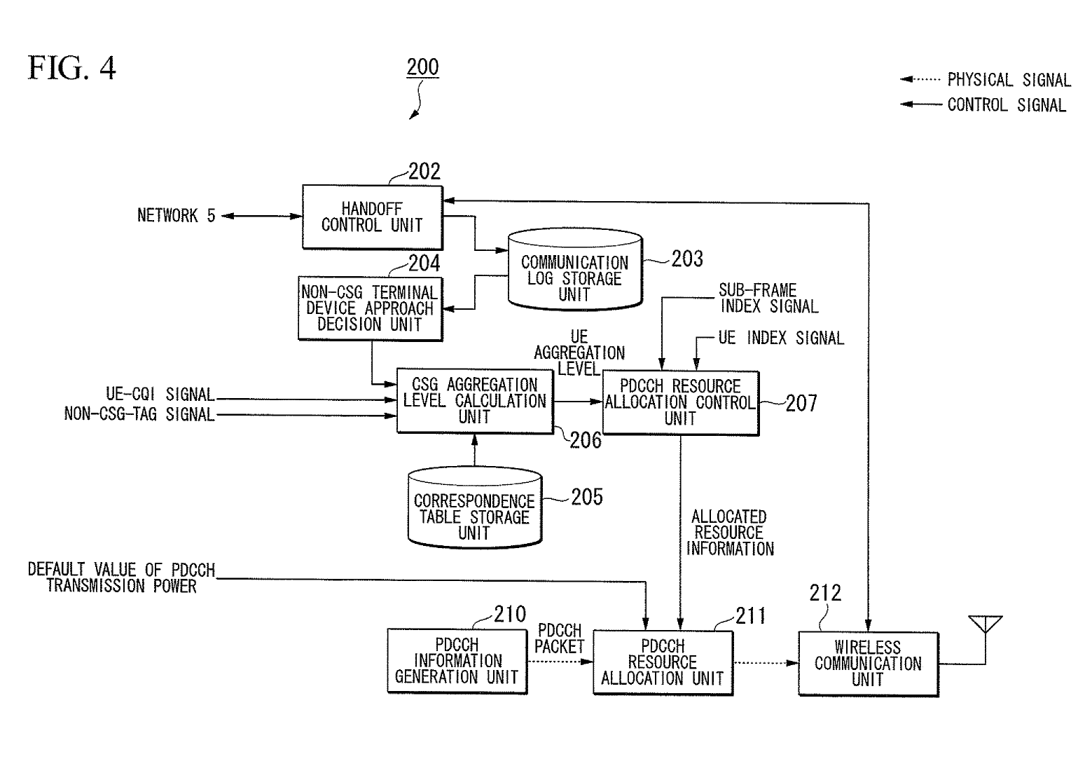

Next, the macro-base station device 200 will be described in detail. FIG. 4 is a block diagram of the macro-base station device 200 included in the wireless communication system 1. The macro-base station device 200 includes a handoff control unit 202, a communication log storage unit 203, a non-CSG terminal device approach decision unit 204, a correspondence table storage unit 205, an aggregation level calculation unit 206, a PDCCH resource allocation control unit 207, a PDCCH information generation unit 210, a PDCCH resource allocation unit 211, and a wireless communication unit 212.

Upon receiving a message, notifying degradation of communication quality, from the non-CSG terminal device 300 (which is currently connected to the macro-base station device 200) via the wireless communication unit 212, the handoff control unit 202 sends a handoff request to another base station device which the non-CSG terminal device 300 approaches via the network 5. Upon receiving a response message to the handoff request, the handoff control unit 202 stores the received response message in the communication log storage unit 203. The communication log storage unit 203 stores messages received by the handoff control unit 202.

Based on messages stored in the communication log storage unit 203, the non-CSG terminal device approach decision unit 204 makes a decision as to whether or not the non-CSG terminal device 300 (which is currently connected to the macro-base station device 200) approaches the CSG base station device 100 in accordance with the following procedure.

The non-CSG terminal device approach decision unit 204 detects the number of messages, each declining the handoff request by the non-CSG terminal device 300, received in a predetermined preceding time period among messages stored in the communication log storage unit 203, thus making a decision as to whether or not the detected number of messages is equal to or above a predetermined threshold.

When the detected number of messages is equal to or above the predetermined threshold, the non-CSG terminal device approach decision unit 204 determines that the non-CSG terminal device 300 (which is currently connected to the macro-base station device 200) approaches the CSG base station device 100. In contrast, when the detected number of messages is less than the predetermined threshold, the non-CSG terminal device approach decision unit 204 determines that the non-CSG terminal device 300 does not approach the CSG base station device 100.

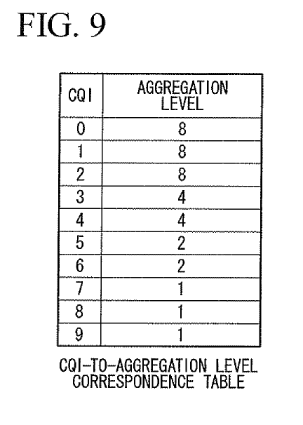

The correspondence table storage unit 205 stores a CQI-to-aggregation level correspondence table in advance. As shown in FIG. 9, aggregation levels are connected to CQI values in the CQI-to-aggregation level correspondence table.

The aggregation level calculation unit 206 receives a UE-CQI signal fed back from the non-CSG terminal device 300 (which is currently connected to the macro-base station device 200), a non-CQI target aggregation level signal (i.e. a non-CSG-TAG signal), and a decision result of the non-CSG terminal device approach decision unit 204. Based on the UE-CQI signal, the non-CSG-TAG signal, and the decision result, the aggregation level calculation unit 206 calculates an aggregation level (i.e. a UE aggregation level) with respect to the non-CSG terminal device 300 feeding back the UE-CQI signal.

The non-CSG-TAG signal indicates an aggregation level applied to the non-CSG terminal device 300 (which is currently connected to the macro-base station device 200) which approaches the CSG base station device 100. An aggregation level of the non-CSG-TAG signal is determined through simulation or measurement, wherein this aggregation level is higher than an average value of aggregation levels applied to the non-CSG terminal device 300. For instance, when an average value of aggregation levels is “4”, the target aggregation level is set to “8” in the macro-base station device 200. Alternatively, it is possible to set the maximum value as the target aggregation level.

Specifically, when the non-CSG terminal device approach decision unit 204 determines that the non-CSG terminal device 300 (which is currently connected to the macro-base station device 200) approaches the CSG base station device 100, the aggregation level calculation unit 206 outputs the aggregation level of the non-CSG-TAG signal as the UE aggregation level. In contrast, when the non-CSG terminal device approach decision unit 204 determines that the non-CSG terminal device 300 does not approach the CSG base station device 100, the aggregation level calculation unit 206 reads the aggregation level, corresponding to the CQI value of the UE-CQI signal, from the correspondence table storage unit 205, thus outputting the read aggregation level as the UE aggregation level.

Similar to the DPCCH resource allocation control unit 107 installed in the CSG base station device 100, the PDCCH resource allocation control unit 207 selects an appropriate value of CCE, allocable to the non-CSG terminal device 300, based on the UE aggregation level, the sub-frame index signal, and the UE index signal of the non-CSG terminal device 300, thus outputting allocated resource information indicating the selected CCE. The PDCCH information generation unit 210 generates PDCCH packets indicating PDSCH and/or PUSCH allocated to the non-CSG terminal device 300.

The PDCCH resource allocation unit 211 allocates PDCCH packets, generated by the PDCCH information generation unit 210, to the CCE indicated by the allocated resource information which is calculated by the PDCCH resource allocation control unit 207. Additionally, the PDCCH resource allocation unit 211 produces OFDM symbols such that transmission power of PDCCH packets matches with the default value of PDCCH transmission power. The wireless communication unit 212 transmits a sub-frame including OFDM symbols produced by the PDCCH resource allocation unit 211.

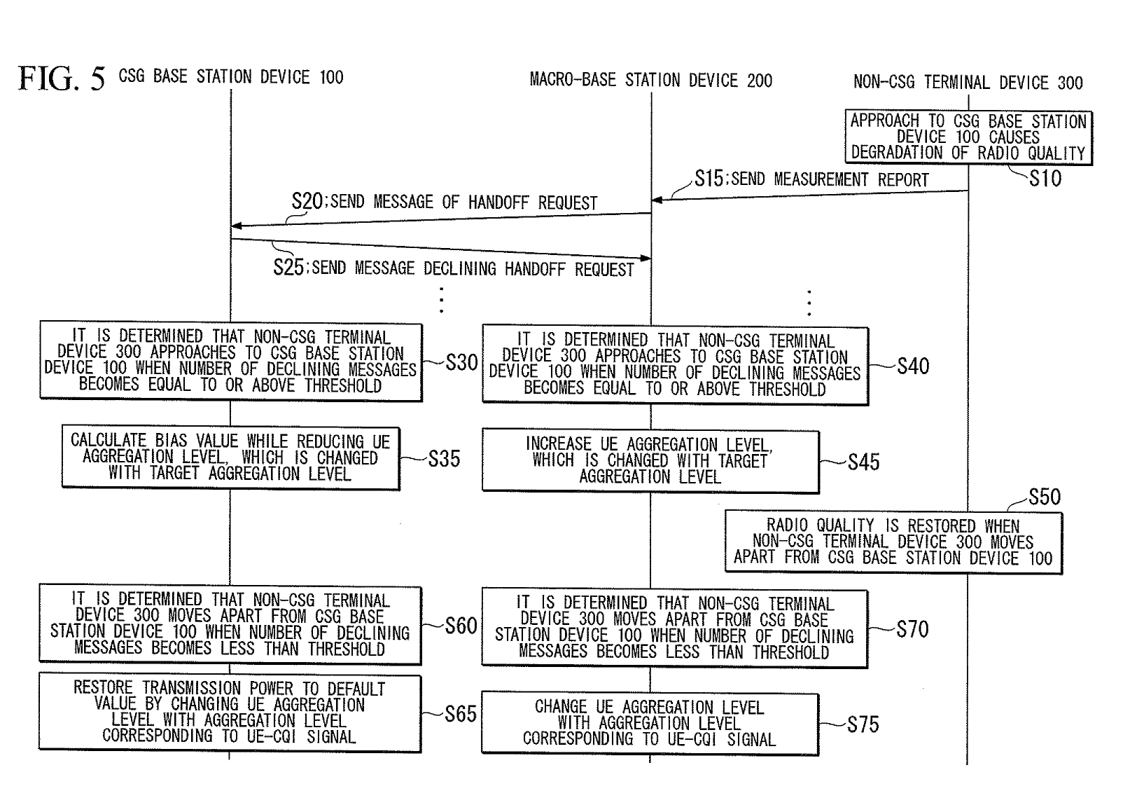

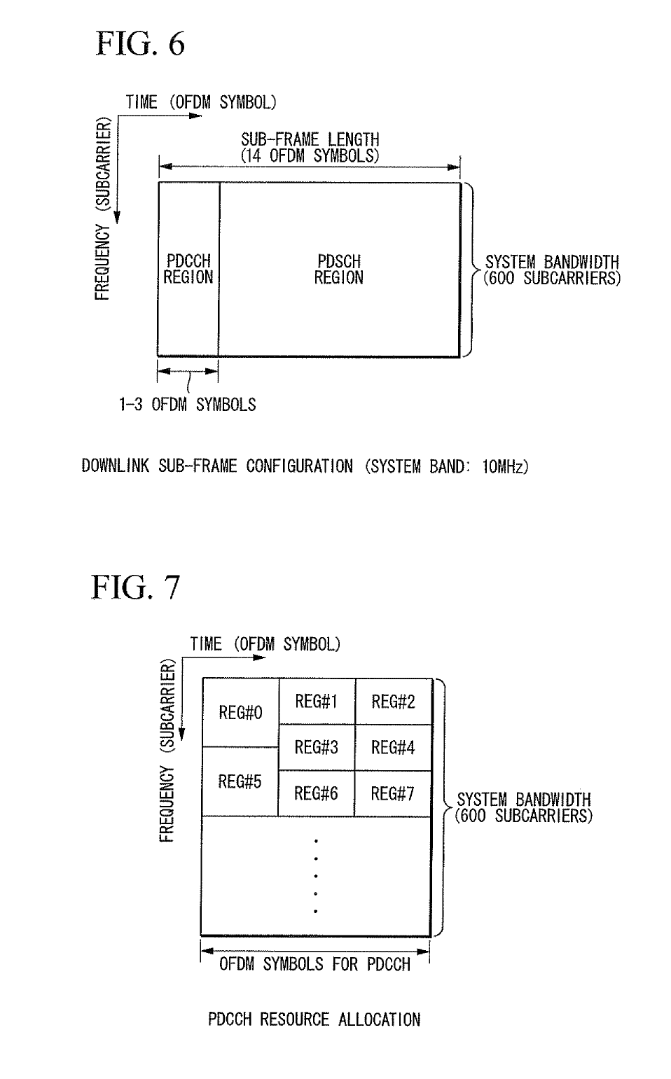

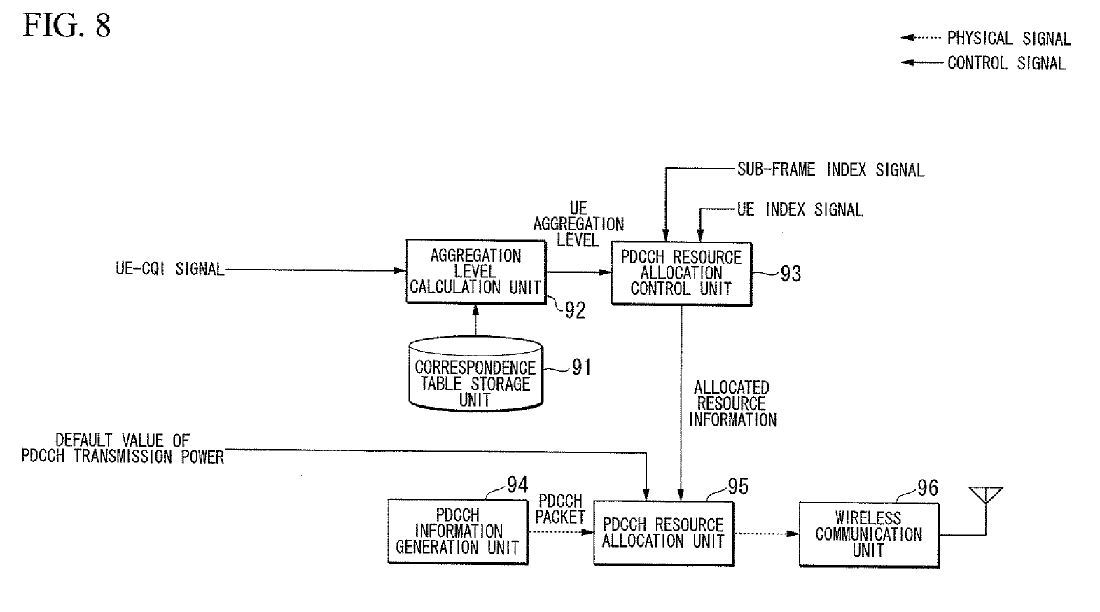

Next, a series of processing implemented by the CSG base station device 100 and the macro-base station device 200 will be described with respect to the situation in which the non-CSG terminal device 300 (which is connected to the macro-base station device 200) approaches the CSG base station device 100 and is temporarily located in the communication area 100A of the CSG base station device 100, thereafter, the non-CSG terminal device 300 moves out from the communication area 100A. FIG. 5 is a sequence diagram illustrating a series of processing conducted in the wireless communication system 1.

When the non-CSG terminal device 300 (which is currently connected to the macro-base station device 200) approaches the CSG base station device 100, signals transmitted by the macro-base station device 200 interfere with signals transmitted by the CSG base station device 100 so that radio quality of the non-CSG terminal device 300 is degraded (step S10). The non-CSG terminal device 300 sends a message, representing degradation of radio quality, to the macro-base station device 200 (step S15).

For instance, this message is equivalent to “TriggerA3” or “TriggerA5” of “Measurement Report”. Herein, TriggerA3 is output based on high/low relationship between reception power from the macro-base station 200 (called a serving sector) and reception power from the CSG base station device 100 (called a neighbor sector), whilst TriggerA5 is output when reception power from the macro-base station device 200 becomes less than a predetermined threshold and when reception power from the CSG base station device 100 becomes equal to or above the predetermined threshold.

Upon receiving the message indicative of the degradation of radio quality from the non-CSG terminal device 300 (which is currently connected to the macro-base station device 200), the handoff control unit 202 sends a message, including the index of the non-CSG terminal device 300 and a handoff request of the non-CSG terminal device 300, to the CSG base station device 100 which the non-CSG terminal device approaches (step S20).

When the handoff control unit 102 determines that the index included in the message output from the macro-base station device 200 is not stored in the connection-permitted list storage unit 101, the CSG base station device 100 sends back a message declining the handoff request to the macro-base station device 200 (step S25).

While the non-CSG terminal device 300 continuously approaches the macro-base station device 200, the foregoing steps S15, S20, and S25 are repeated so that the handoff control unit 102 of the CSG base station device 100 consecutively transmits the message declining the handoff request (HO Preparation Failure). This increases the number of messages declining handoff requests which are stored in both the communication log storage unit 103 of the CSG base station device 100 and the communication log storage unit 203 of the macro-base station device 200.

Thereafter, when the number of messages declining handoff requests, which have been stored in the communication log storage unit 103 of the CSG base station device 100 in the predetermined preceding time period, becomes equal to or above the predetermined threshold, the non-CSG terminal device approach decision unit 104 determines that the non-CSG terminal device 300 approaches the CSG base station device 100 (step S30).

Based on the decision result of the non-CSG terminal device approach decision unit 104, the CSG aggregation level calculation unit 106 changes the UE aggregation level with the aggregation level of the CSG-TAG signal, thus reducing the UE aggregation level. In response to a change of the UE aggregation level, the PDCCH resource allocation control unit 107 decreases the number of CCE allocated to the CSG terminal device 301.

Based on the decision result of the non-CSG terminal device approach decision unit 104, the transmission power bias calculation unit 108 calculates a bias value so as to obtain a desired SINR value corresponding to the aggregation level of the CSG-TAG signal, thus increasing transmission power of CCE allocated to the CSG terminal device 301. This reduces the frequency range allocated to the CSG terminal device 301 (step S35).

Similarly, when the number of messages declining handoff requests, which have been stored in the communication log storage unit 203 of the macro-base station device 200, becomes equal to or above the predetermined threshold, the non-CSG terminal device approach decision unit 204 determines that the non-CSG terminal device 300 (which is currently connected to the macro-base station device 200) approaches the CSG base station device 100 (step S40).

Based on the decision result of the non-CSG terminal device approach decision unit 204, the aggregation level calculation unit 206 changes the UE aggregation level for the non-CSG terminal device 300 with the aggregation level of the non-CSG-TAG signal. In response to a change of the UE aggregation level, the PDCCH resource allocation control unit 207 increases the number of CCE allocated to the non-CSG terminal device 300. This broadens the frequency range allocated to the non-CSG terminal device 300 (step S45).

The radio quality of the non-CSG terminal device 300 is restored when the non-CSG terminal device 300 moves out from the communication area 100A of the CSG base station device 100. Thus, the non-CSG terminal device 300 stops sending a message indicative of the degradation of radio quality to the macro-base station device 200 (step S50).

As a result, the macro-base station device 200 stops sending a handoff request message (HO Preparation Failure) to the CSG base station device 100. This decreases the number of messages declining handoff requests which have been stored in both the communication log storage unit 103 of the CSG base station device 100 and the communication log storage unit 203 of the macro-base station device 200 in the predetermined preceding time period.

In the CSG base station device 100, when the number of messages declining handoff requests stored in the communication log storage unit 103 becomes less than the predetermined threshold, the non-CSG terminal device approach decision unit 104 determines that the non-CSG terminal device 300 no longer approaches the CSG base station device 100 (step S60).

Based on the decision result of the non-CSG terminal device approach decision unit 104, the CSG aggregation level calculation unit 106 changes the UE aggregation level applied to the CSG terminal device 301 with the aggregation level corresponding to the UE-CQI signal fed back from the CSG terminal device 301. Additionally, the transmission power bias calculation unit 108 changes transmission power of PDCCH packets, which are transmitted to the CSG terminal device 301, with the default value of PDCCH transmission power (step S65).

Similarly, in the macro-base station device 200, when the number of messages declining handoff requests stored in the communication log storage unit 203 becomes less than the predetermined threshold, the non-CSG terminal device approach decision unit 204 determines that the non-CSG terminal device 300 (which is connected to the macro-base station device 200) no longer approaches the CSG base station device 100 (step S70).

Based on the decision result of the non-CSG terminal device approach decision unit 204, the aggregation level calculation unit 206 changes the UE aggregation level applied to the non-CSG terminal device 300 with the aggregation level corresponding to the UE-CQI signal fed back from the non-CSG terminal device 300 (step S75).

As described above, when the non-CSG terminal device 300 (which is currently connected to the macro-base station device 200) approaches the CSG base station device 100 without being subjected to handoff to the CSG base station device 100 in the wireless communication system 1, both the non-CSG terminal device approach decision unit 104 of the CSG base station device 100 and the non-CSG terminal device approach decision unit 204 of the macro-base station device 200 determine that the non-CSG terminal device 300 approaches the CSG base station device 100.

When the non-CSG terminal device 300 approaches the CSG base station device 200, the CSG aggregation level calculation unit 106 decreases the aggregation level applied to the CSG terminal device 301 (which is currently connected to the CSG base station device 200) to be lower than the aggregation level which is determined based on radio quality with the CSG terminal device 301. This reduces the number of CCE used for disposing PDCCH packets transmitted to the CSG terminal device 301. In other words, this reduces the frequency band used for transmitting PDCCH packets (or control signals) to the CSG terminal device 301.

Thus, even when the macro-base station device 200 and the CSG base station device conduct communication using the same frequency range, it is possible to reduce a probability in which the frequency band for disposing PDCCH packets transmitted from the macro-base station device 200 to the non-CSG terminal device 300 may overlap with the frequency band for disposing PDCCH packets transmitted from the CSG base station device 100 to the CSG terminal device 301, thus reducing interference with the non-CSG terminal device 300.

Based on the decision result of the non-CSG terminal device approach decision unit 204, the macro-base station device 200 increases the aggregation level applied to the non-CSG terminal device 300 so as to increase the number of CCE for disposing PDCCH packets. This broadens the frequency band used for transmitting PDCCH packets (or control signals) to the non-CSG terminal device 300, thus reducing the coding rate.

Thus, even when the frequency band (i.e. REG: Resource Element Group) for disposing PDCCH packets transmitted from the macro-base station device 200 to the non-CSG terminal device 300 overlaps with the frequency band for disposing PDCCH packets transmitted from the CSG base station device 100 to the CSG terminal device 301, the non-CSG terminal device 300 is able to perform error correction decoding using signals received in a non-overlapped frequency band. Since the present embodiment adopts a low coding rate in transmitting PDCCH packets, it is possible to increase a probability in that PDCCH packets can be correctly decoded, thus reducing interference with the non-CSG terminal device 300.

Since the transmission power bias calculation unit 108 calculates a bias value in response to the reduced number of CCE, the CSG base station device 100 is able to increase transmission power for transmitting PDCCH packets to the CSG terminal device 301. Thus, it is possible to prevent degradation of radio quality due to a reduction of the frequency band for transmitting PDCCH packets to the CSG terminal device 301.

The CSG base station device 100 decreases the UE aggregation level applied to the CSG terminal device 301 so as to increase transmission power only when the non-CSG terminal device 300 approaches thereto. Compared to the conventional technology in which the number of CCE applied to the CSG terminal device 301 is normally decreased (or the frequency band is normally decreased) to thereby increase transmission power, it is possible to reduce a negative influence to the periphery of the location of the CSG base station device 100. Additionally, it is possible to suppress an increase of processing load to the CSG base station device 100.

As described above, the CSG base station device 100 cooperates with the macro-base station device 200 so as to reduce interference with PDCCH packets, whose frequency band (or CCE) must be determined based on the sub-frame index and the terminal device index, irrespective of radio quality. Additionally, it is possible to reduce a probability in that the non-CSG terminal device 300 fails to demodulate PDCCH packets transmitted thereto from the macro-base station device 200, whereby it is possible to prevent communication breakdown with the non-CSG terminal device 300.

The present embodiment is described with respect to the simple constitution of the wireless communication system 1 which includes one CSG base station device 100, one macro-base station device 200, one non-CSG terminal device 300, and one CSG terminal device 301; but this is not a restriction. It is possible to arrange two or more devices as each constituent element. A decision as to whether or not a plurality of non-CSG terminal devices 300 approaches the CSG base station device 100 is made using UE indexes, identifying the non-CGS terminal devices 300, per each non-CGS terminal device 300. In this connection, it is possible to arrange a plurality of CSG base station devices 100 in the communication area 200A of one macro-base station device 200. Additionally, it is possible to arrange a plurality of CSG terminal devices 301 which are permitted to be connected to the CSG base station device 100.

The present embodiment is described such that the connection-permitted list storage unit 101 for storing the UE index of the CSG terminal device 301 having connection permission is installed in the CSG base station device 100; but this is not a restriction. Instead, it is possible to arrange a server for managing a list of indexes of CSG terminal devices 301 each having connection permission with the CSG base station device 100. In this case, the handoff control unit 102 installed in the CSG base station device 100 makes an inquiry, using a UE index received together with a handoff request, to the server so as to make a decision whether or not to accept connection permission.

It is possible to install a computer system in each of the CSG base station device 100 and the macro-base station device 200. Herein, the entire processing implementing the functions of the connection-permitted list storage unit, handoff control unit, communication log storage unit, non-CSG terminal device approach decision unit, correspondence table storage unit, CSG aggregation level calculation unit, PDCCH resource allocation control unit, transmission power bias calculation unit, PDCCH information generation unit, and PDCCH resource allocation unit is stored as programs in computer-readable recording media; hence, the computer system loads and executes those programs to carry out the processing of the present embodiment. Herein, computer-readable recording media refer to magnetic disks, magnetooptic disks, CD-ROM, DVD-ROM, and semiconductor memory. Additionally, it is possible to distribute programs to computer systems via communication lines so that computer systems can load and execute downloaded programs.

### 2. Second Embodiment

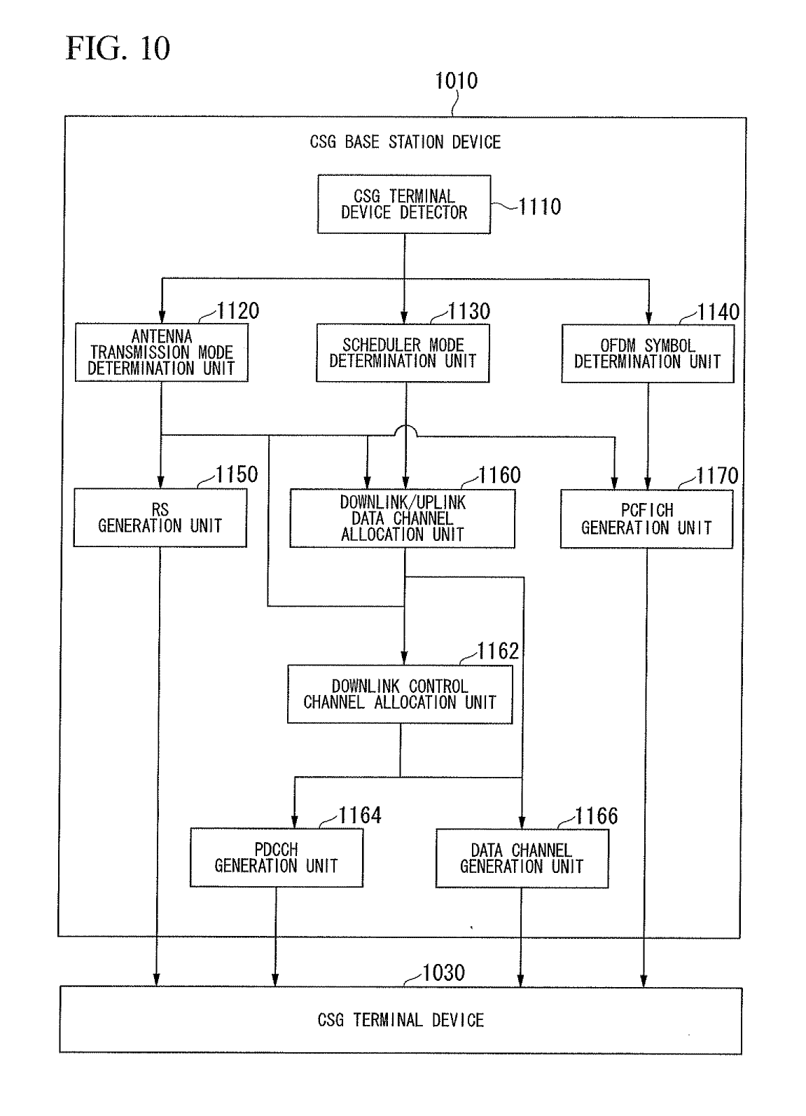

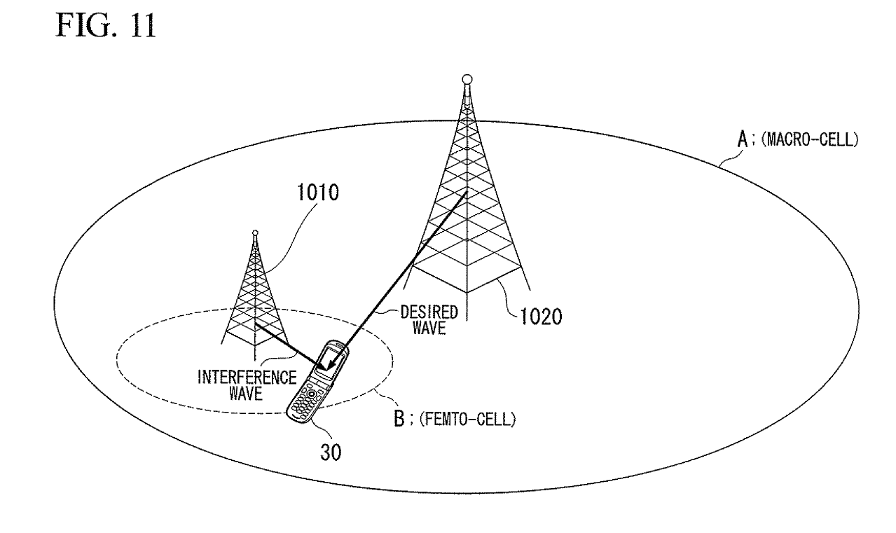

FIG. 10 is a block diagram of a CSG base station device 1010 according to a second embodiment of the present invention. FIG. 11 is a schematic diagram of a wireless communication system including the CSG base station device 1010, a macro-base station device 1020, and a non-CSG terminal device 1030. In this connection, the term “CSG base station device” is equivalent to a CSG base station, and the term “macro-base station device” is equivalent to a macro-base station.

As shown in FIG. 10, the CSG base station device 1010 includes a non-CSG terminal device detector 1110 (serving as an unregistered terminal device existence decision unit), an antenna transmission mode determination unit 1120, a scheduler mode determination unit 1130, an OFDM symbol determination unit 1140, an RS generation unit 1150, a downlink/uplink data channel allocation unit 1160, a downlink control channel allocation unit 1162, a PDCCH generation unit 1164, a data channel generation unit 1166, and a PCFICH generation unit 1170.

The overall constitution of the CSG base station device 1010 is divided into a preprocessor section (including constituent elements 1110, 1120, 1130, 1140) and a postprocessor section (including constituent elements 1150, 1160, 1162, 1164, 1166, and 1170).

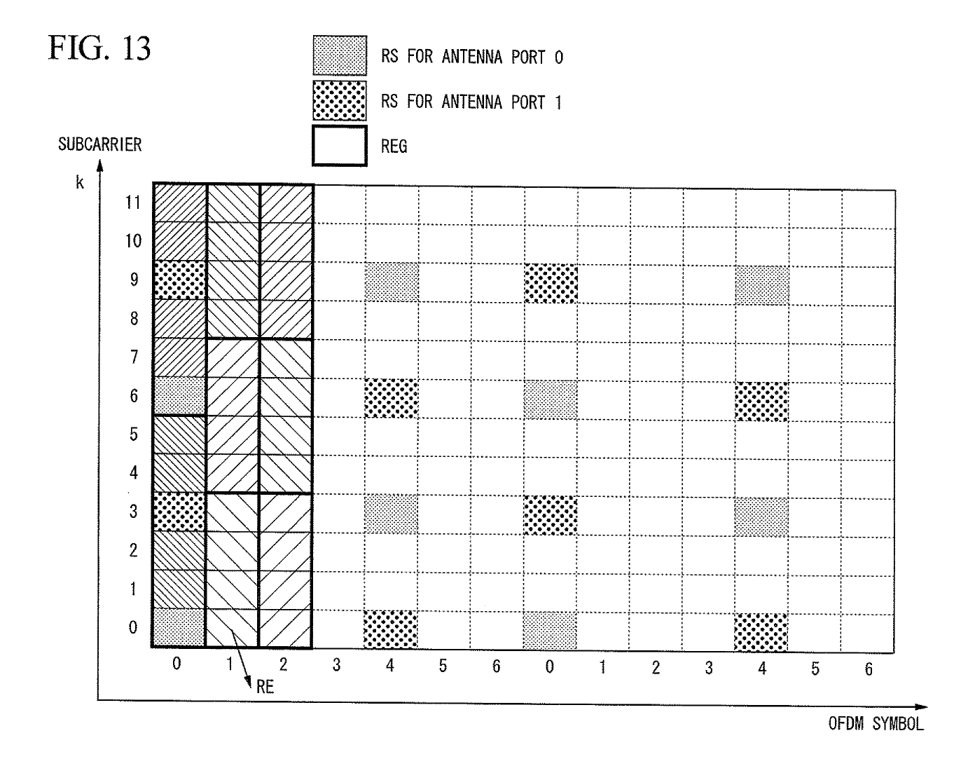

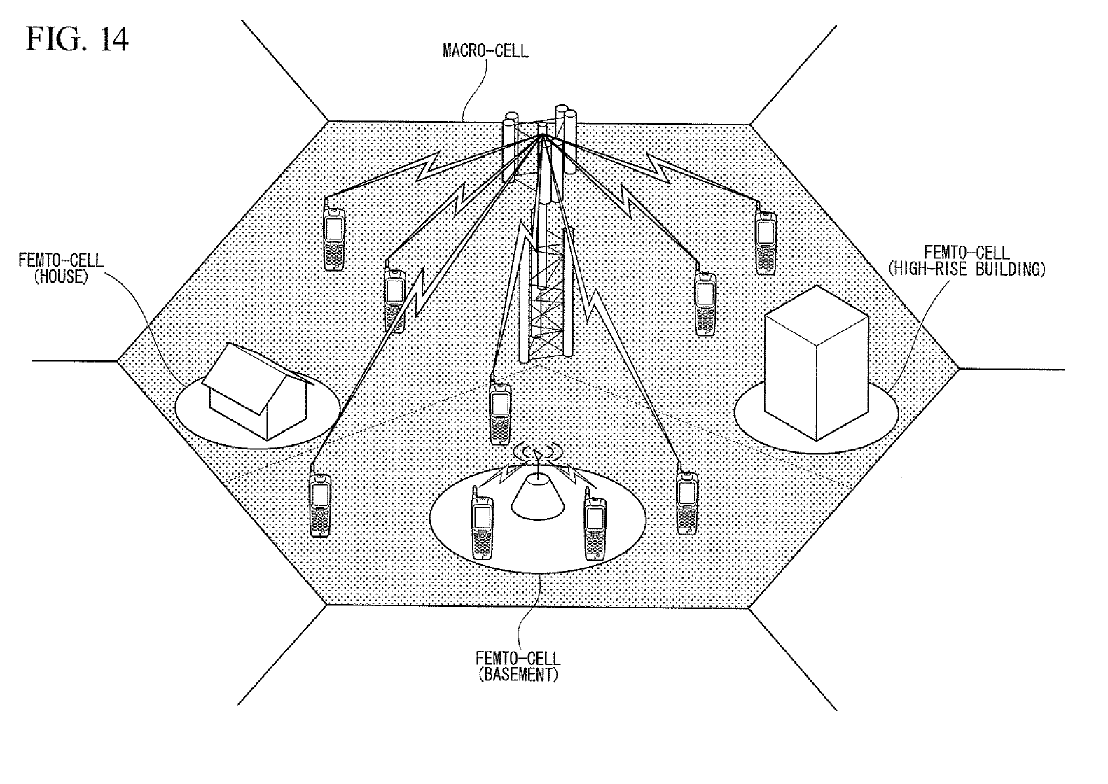

First, the postprocessor section will be described in detail. Based on an antenna transmission mode of the antenna transmission mode determination unit 1120, the RS generation unit 1150 generates an antenna-port RS (i.e. a channel quality measurement signal), which is placed in a certain radio resource (see FIG. 13).

The downlink/uplink data channel allocation unit 1160 determines allocation of radio resources to data channels (PDSCH/PUSCH) based on an antenna transmission mode of the antenna transmission mode determination unit 1120 and a scheduler mode of the scheduler mode determination unit 1130.

The downlink control channel allocation unit 1162 determines allocation of radio resources to PDCCH based on the antenna transmission mode of the antenna transmission mode determination unit 1120 and an allocation result of data channels (PDSCH/PUSCH).

Based on the PDCCH allocation result, the PDCCH generation unit 1164 generates PDCCH, which is placed in a certain radio resource. Based on the PDSCH allocation result and the PDCCH allocation result, the data channel generation unit 1166 generates PDSCH, which is placed in a certain radio resource. Based on the number of OFDM symbols notified by the OFDM symbol determination unit 1140, the PCFICH generation unit 1170 generates PCFICH, which is placed in a certain radio resource.

Next, the preprocessor section (including the constituent elements 1110, 1120, 1130, 1140) will be described in detail. The non-CSG terminal device detector 1110 detects whether or not the non-CSG terminal device 1030 exists in the coverage area of the CSG base station device 1010. Specifically, the non-CSG terminal device detector 1110 detects a first event that the non-CSG terminal device 1130, which was not previously located in the coverage area of the CSG base station device 1010, is currently located in the coverage area, a second event that the non-CSG terminal device 1030, which was previously located in the coverage area of the CSG base station device 1010, is still located in the coverage area, or a third event that the non-CSG terminal device 1030, which was previously located in the coverage area of the CSG base station device 1010, is no longer located in the coverage area. The non-CSG terminal device detector 1110 notifies the detection result (regarding the first, second, or third event) to the antenna transmission mode determination unit 1120, the scheduler mode determination unit 1130, and the OFDM symbol determination unit 1140.

The non-CSG terminal device detector 1110 may adopt various detection methods. For instance, the non-CSG terminal device detector 1110 monitors a handover request of the non-CSG terminal device 1030 transmitted from the macro-base station device 1020, thus detecting whether or not the non-CSG terminal device 1030 exists in the coverage area of the CSG base station device 1010. This detection method will be described with respect to the situation of FIG. 2 in which the non-CSG terminal device 1030 moves toward the coverage area of the CSG base station device 1010 (i.e. a femto-cell B) inside the coverage area of the macro-base station device 1020 (i.e. a macro-cell A), wherein the macro-base station device 1020 transmits a handover request to the CSG base station device 1010. When the CSG base station device 1010 has consecutively receive handover requests, the number of which becomes equal to or above a predetermined threshold in a predetermined preceding time period, from the macro-base station device 1020, the non-CSG terminal device detector 1110 detects that the non-CSG terminal device 1030 exists in the coverage area of the CSG base station device 1010. When the non-CSG terminal device 1030 moves apart from the coverage area of the CSG base station device 1010, the macro-base station device 1020 no longer transmits a handover request to the CSG base station device 1010. That is, when the CSG base station device 1010 has not received any handover request from the macro-base station device 1020 in a certain time period, the non-CSG terminal device detector 1110 detects that the non-CSG terminal device 1030 no longer exists in the coverage area of the CSG base station device 1010.

The antenna transmission mode determination unit 1120 retrieves the detection result regarding the existence of the non-CSG terminal device 1030 from the non-CSG terminal device detector 1110. Based on the detection result of the non-CSG terminal device detector 1110, the antenna transmission mode determination unit 1120 determines an antenna transmission mode with respect to the CSG base station device 1010. The antenna transmission mode determination unit 1120 notifies the antenna transmission mode to the RS generation unit 1150, the downlink/uplink data channel allocation unit 1160, the downlink control channel allocation unit 1162, and the PDFICH generation unit 1170.

Next, a method for determining an antenna transmission mode will be described with respect to the following cases.

(1) The non-CSG terminal device 1030 does not exist in the coverage area of the CSG base station device 1010.

Upon receiving the detection result that the non-CSG terminal device 1030 does not exist in the coverage area of the CSG base station device 1010, the antenna transmission mode determination unit 1120 determines an antenna transmission mode based on the number of antennas installed in the CSG base station device 1010. When the CSG base station device 1010 is equipped with two antennas, for example, the antenna transmission mode determination unit 1120 determines a multi-antenna transmission mode using two antennas. The RS generation unit 1150 generates channel quality measurement signals (i.e. reference signals, RS) in connection with two antenna ports (namely, 0 and 1) so that those signals are placed in radio resources (see FIG. 13). Additionally, PCFICH and PDCCH are placed in connection with two antenna ports. The PDSCH allocation is performed in the multi-antenna transmission mode.

(2) The non-CSG terminal device 1030 exists in the coverage area of the CSG base station device 1010.

Upon receiving the detection result that the non-CSG terminal device 1030 exists in the coverage area of the CSG base station device 1010, the antenna transmission mode determination unit 1120 determines an antenna transmission mode of the CSG base station device 1010 in response to existence or nonexistence of antenna information representing the number of antennas installed in the macro-base station device 1020.

(2-1) No antenna information is provided with regard to the number of antennas installed in the macro-base station device 1020.

Regardless of the number of antennas installed in the CSG base station device 1010, the antenna transmissions mode determination unit 1120 sets a single-antenna transmission mode to the CSG base station device 1010. Additionally, the antenna transmission mode determination unit 1120 selects an antenna port (used for the single-antenna transmission mode) having a higher average value of Wideband CQI (Wideband Channel quality) fed back to the CSG base station device 1010. When the CSG base station device 1010 is equipped with two antennas, the RS generation unit 1150 generates a reference signal (RF) with antenna port 0 (or 1) alone, which is placed in a certain radio resource (see FIG. 13). Additionally, PCFICH and PDCCH are each arranged in connection with antenna port 0 (or 1) alone. In this connection, the PDSCH allocation is performed in the single-antenna transmission mode.

(2-2) Antenna information is provided with regard to the number of antennas installed in the macro-base station device 1020.

The antenna transmission mode determination unit 1120 determines an antenna transmission mode of the CSG base station device 1010 based on the following condition. Specifically, the antenna transmission mode determination unit 1120 determines an antenna transmission mode of the CSG base station device 1010 based on the relationship between the number of antennas of the macro-base station device 1020 and the number of antennas of the CSG base station device 1010. More specifically, the antenna transmission mode determination unit 1120 determines an antenna transmission mode of the CSG base station device 1010 based on the number of antennas of the macro-base station device 1020 minus N and the number of antennas of the CSG base station device 1010. Herein, “N” denotes an input parameter which is designated in advance.

(2-2-1) The number of antennas of the macro-base station device 1020 minus N>the number of antennas of the CSG base station device.

The antenna transmission mode determination unit 1120 determines an antenna transmission mode of the CSG base station device 1010 based on the number of antennas installed in the CSG base station device 1010. Specifically, when the CSG base station device 1010 is equipped with a single antenna, the antenna transmission mode determination unit 1120 sets a single-antenna transmission mode to the CSG base station device 1010. When the number of antennas of the CSG base station device 1010>1, the antenna transmission mode determination unit 1120 sets a multi-antenna transmission mode to the CSG base station device 1010, wherein the number of transmission antennas is equal to the number of antennas of the CSG base station device 1010.

(2-2-2) The number of antennas of the macro-base station device minus N≦1.

The antenna transmission mode determination unit 1120 sets a single-antenna transmission mode to the CSG base station device 1010.

As described above, the CSG base station device 1010 transmits signals using a small number of antennas which is smaller than the number of antennas of the macro-base station device 1020; hence, it is possible to reduce interference of the CSG base station device 1010 with a downlink physical control channel, which is received from the macro-base station device 1020 by the non-CSG terminal device 1030 currently located in the femto-cell of the CSG base station device 1010.

Even when an RS arrangement of the CSG base station device 1010 overlaps with an RS arrangement of the macro-base station device 1020, the CSG base station device 1010 no longer interferes with RS reception with antenna port 1 (or antenna port 0) of the macro-base station device 1020 by the non-CSG terminal device 1030 located in the coverage area of the CSG base station device 1010; hence, “Radio link failure” no longer occurs.

Even when an RS arrangement of the CSG base station device 1010 overlaps with a PCFICH/PDCCH arrangement of the macro-base station device 1020, the CSG base station device 1010 is able to reduce its interference with PCFICH/PDCCH reception with antenna port 1 (or antenna port 0) of the macro-base station device 1020 by the non-CSG terminal device 1030 located in the coverage area of the CSG base station device 1010.

The scheduler mode determination unit 1130 retrieves the detection result of the non-CSG terminal device 1030 from the non-CSG terminal device detector 1110. The scheduler mode determination unit 1130 determines a scheduler mode of the CSG base station device 1010 based on the detection result of the non-CSG terminal device 1030. The scheduler mode determination unit 1130 notifies the scheduler mode to the downlink/uplink data channel allocation unit 1160.

Next, a method for determining a scheduler mode will be described with respect to the following cases.

(1) The non-CSG terminal device 1030 does not exist in the coverage area of the CSG base station device 1010.

Upon retrieving the detection result that the non-CSG terminal device 1030 does not exist in the coverage area of the CSG base station device 1010, the scheduler mode determination unit 1130 sets a dynamic scheduler mode to the CSG base station device 1010. In the dynamic scheduler mode, the downlink/uplink data channel allocation unit 1160 allocates radio resources to PDSCH/PUSCH of each CSG terminal per each sub-frame based on CQI information fed back from each CSG terminal device.

(2) The non-CSG terminal device 1030 exists in the coverage area of the CSG base station device 1010.

Upon retrieving the detection result that the non-CSG terminal device 1030 exists in the coverage area of the CSG base station device 1010, the scheduler mode determination unit 1130 sets a semi-persistent scheduler mode to the CSG base station device 1010. In the semi-persistent scheduler mode, the downlink/uplink data channel allocation unit 1160 conducts radio resource allocation in a quasistatic (or static) manner; hence, it does not need PDCCH for notifying each CSG terminal device of PDSCH/PUSCH allocated radio resources per each sub-frame.

As described above, the semi-persistent scheduler mode is employed when the non-CSG terminal device 1030 exists in the femto-cell of the CSG base station device 1010, so that the CSG base station device 1010 is able to reduce its interference with a downlink physical control channel, received from the macro-base station device 1020, by the non-CSG terminal device 1030 located in the femto-cell.

Even when a PDCCH arrangement of the CSG base station device 1010 overlaps with an RS arrangement of the macro-base station 1020, the CSG base station device 1010 does not need to transmit PDCCH in the semi-persistent scheduler mode; hence, the CSG base station device 1010 does not interfere with RS reception, from the macro-base station device 1020, by the non-CSG terminal device 1030 located in the coverage area of the CSG base station device 1010. This prevents occurrence of “Radio link failure”.

Even when an RS arrangement of the CSG base station device 1010 overlaps with a PCFICH/PDCCH arrangement of the macro-base station device 1020, the CSG base station device 1010 does not need to transmit PDCCH in the semi-persistent scheduler mode; hence, the CSG base station device 1020 is able to reduce its interference with PCFICH/PDCCH reception, from the macro-base station 1020, by the non-CSG terminal device 1020 located in the coverage area of the CSG base station device 1010.

In the semi-persistent scheduler mode, the scheduler mode determination unit 1130 may periodically or in an event-driven manner change the semi-persistent scheduler mode with the dynamic scheduler mode in order to reconsider radio resource allocation. Specifically, a timer is used to start counting time when the scheduler mode determination unit 1130 switches to the semi-persistent scheduler mode; thereafter, when a predetermined time has elapsed, the scheduler mode is switched from the semi-persistent scheduler mode to the dynamic scheduler mode. Alternatively, when a CSG terminal which is newly placed in an RCC_Connected states exists in the coverage area of the CSG base station device 1010, the scheduler mode is switched from the semi-persistent scheduler mode to the dynamic scheduler mode. When the scheduler mode is switched to the dynamic scheduler mode, the downlink/uplink data channel allocation unit 1160 allocates radio resources. Thereafter, the scheduler mode determination unit 1130 switches the scheduler mode from the dynamic scheduler mode to the semi-persistent scheduler mode when the non-CSG terminal device 1030 exists in the coverage area of the CSG base station device 1010. When a predetermined time of ten seconds is set to the timer, for example, the scheduler mode determination unit 1130 sets the semi-persistent scheduler mode upon detecting the existence of the non-CSG terminal device 1030; then, after ten seconds have elapsed, the scheduler mode determination unit 1130 changes the semi-persistent scheduler mode with the dynamic scheduler mode. Due to the switching to the dynamic scheduler mode, the downlink/uplink data channel allocation unit 1160 allocates radio resources. Thereafter, if the non-CSG terminal device 1030 has still existed in the coverage area, the scheduler mode determination unit 1130 changes the dynamic scheduler mode with the semi-persistent scheduler mode.

As described above, the scheduler mode is changed periodically or in an event-driven manner to reconsider radio resource allocation; in other words, even when the non-CSG terminal device 1030 has continuously existed for a long time in the coverage area of the CSG base station device 1010, it is possible to periodically reconsider radio resource allocation.

The OFDM symbol determination unit 1140 retrieves the detection result of the non-CSG terminal device 1030 from the non-CSG terminal device detector 1110. The OFDM symbol determination unit 1140 determines the number of OFDM symbols, used for PDCCH in the CSG base station device 1010, based on the detection result of the non-CSG terminal device 1030. The OFDM symbol determination unit 1140 notifies the number of OFDM symbols to the PCFICH generation unit 1170.

Next, a method for determining the number of OFDM symbols used for PDCCH will be described with respect to the following cases.

(1) The non-CSG terminal device does not exist in the coverage area of the CSG base station device 1010.

Upon retrieving the detection result that the non-CSG terminal device 1030 does not exist in the coverage area of the CSG base station device 1010, the OFDM symbol determination unit 1140 sets a non-zero number to the number of OFDM symbols used for PDCCH in the CSG base station device 1010. When the number of ODFM symbols is not zero, the PCFICH generation unit 1170 needs to transmit PCFICH.

(2) The non-CSG terminal device 1030 exists in the coverage area of the CSG base station device 1010.

Upon retrieving the detection result that the non-CSG terminal device 1030 exists in the coverage area of the CSG base station device 1010, the OFDM symbol determination unit 1140 sets the number of OFDM symbols, used for PDCCH in the CSG base station device 1010, to zero. When the number of ODFM symbols used for PDCCH is zero (e.g. the number of OFDM symbols is set to zero in the semi-persistent scheduler mode because this mode does not need PDCCH), the PCFICH generation unit 1170 does not need to transmit PCFICH.

As described above, the number of OFDM symbols used for PDCCH is set to zero when the non-CSG terminal device 1030 exists in the femto-cell of the CSG base station device 1010; hence, the CSG base station device 1010 is able to reduce its interference with a downlink physical control channel, received from the macro-base station 1020, by the non-CSG terminal device 1030 located in the femto-cell.

Even when a PCFICH arrangement of the CSG base station device 1010 overlaps with an RS arrangement of the macro-base station device 1020, the CSG base station device 1010 does not need to transmit PCFICH since the number of OFDM symbols is set to zero. Thus, the CSG base station device 1010 does not interfere with RS reception, from the macro-base station device 1020, by the non-CSG terminal device 1030 located in the coverage area of the CSG base station device 1010. This prevents occurrence of “Radio link failure”.

Even when a PCFICH arrangement of the CSG base station device 1010 overlaps with a PCFICH/PDCCH arrangement of the macro-base station device 1020, the CSG base station device 1010 does not need to transmit PCFICH since the number of OFDM symbols is set to zero; hence, the CSG base station device 1010 does not interfere with PCFICH/PCDDH reception, from the macro-base station device 1020, by the non-CSG terminal device located in the coverage area of the CSG base station device 1010.

The OFDM symbol determination unit 1140 may periodically or in an event-driven manner change the number of OFDM symbols from zero to a non-zero number to reconsider radio resource allocation. Specifically, a timer is used to start counting time when the OFDM symbol determination unit 1140 sets zero to the number of OFDM symbols used for PDCCH; then, after a predetermined time has elapsed, the OFDM symbol determination unit 1140 changes the number of OFDM symbols from zero to a non-zero number. Alternatively, the OFDM symbol determination unit 1140 changes the number of OFDM symbols from zero to a non-zero number when a CSG terminal device which is newly placed in an RRC_Connected state exists in the coverage area of the CSG base station device 1010. Since the number of ODFM symbols is changed to a non-zero number, the downlink/uplink data channel allocation unit 1160 allocates radio resources in the dynamic scheduler mode; thereafter, the PCFICH generation unit 1170 is able to transmit PCFICH. Thereafter, the OFDM symbol determination unit 1140 changes the number of ODFM symbols from a non-zero number to zero when the non-CSG terminal device 1030 exists in the coverage area of the CSG base station device 1010. When a predetermined time of ten seconds is set to the timer, for example, the OFDM symbol determination unit 1140 sets zero to the number of OFDM symbols upon detecting the existence of the non-CSG terminal device 1030; then, after ten seconds has elapsed, the OFDM symbol determination unit 1140 changes the number of OFDM symbols from zero to a non-zero number. Since the number of OFDM symbols is changed to a non-zero number, the PCFICH generation unit 1170 is able to transmit PCFICH. Thereafter, the OFDM symbol determination unit 1140 may change the number of OFDM symbols from a non-zero number to zero if the non-CSG terminal device 1030 still exists in the coverage area.

As described above, the number of OFDM symbols is changed from zero to non-zero number periodically or in an event-driven manner, whereby it is possible to reconsider radio resource allocation and transmit PCFICH even when the non-CSG terminal device 1030 has still existed in the coverage area of the CSG base station device 1010 for a long time. In this connection, the PDCCH generation unit 1164 needs to transmit PDCCH when the scheduler mode is switched to the dynamic scheduler mode to reconsider radio resource allocation, so that the PCFICH generation unit 1170 needs to transmit PCFICH. For this reason, the timing for changing the number of OFDM symbols used for PDCCH is synchronized with the timing for changing the scheduler mode. In other words, the same timer is used for both the operation of changing the number of OFDM symbols used for PDCCH and the operation of changing the scheduler mode.

Next, the operation of the CSG base station device 1010 will be described in detail.

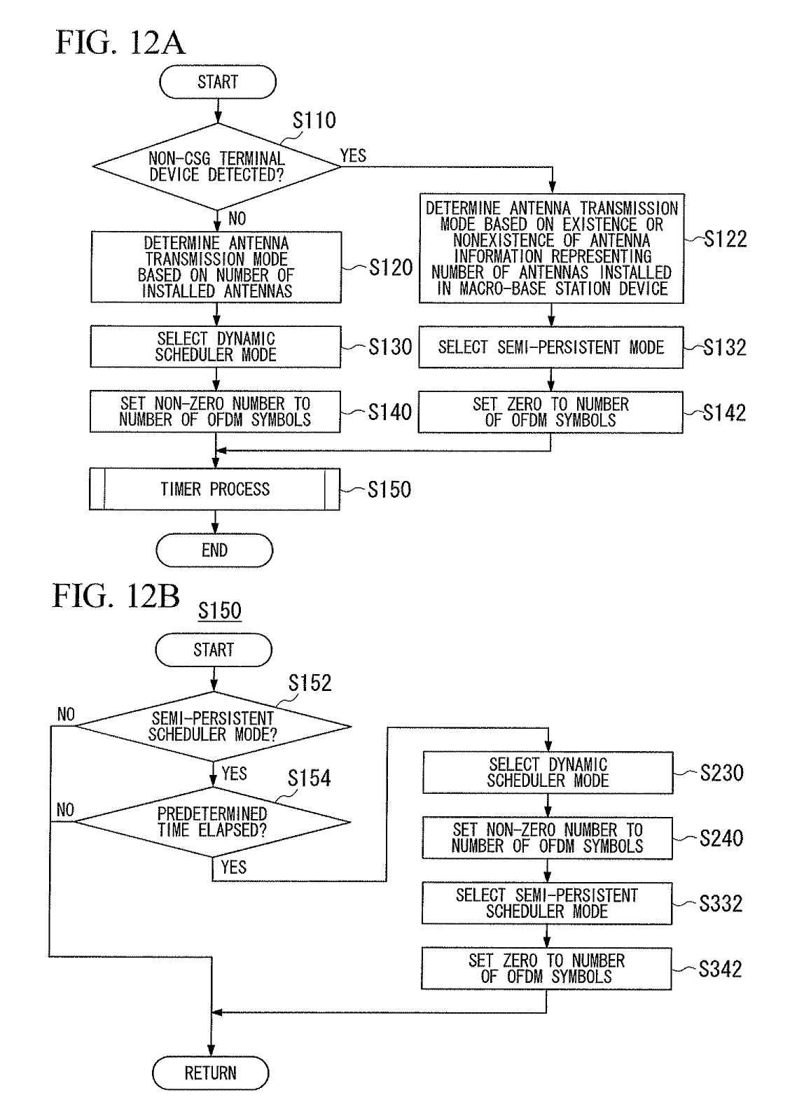

FIGS. 12A and 12B are flowcharts showing the operation of the CSG base station device 1010, illustrating functions of the non-CSG terminal device detector 1110, the antenna transmission mode determination unit 1120, the scheduler mode determination unit 1130, and the OFDM symbol determination unit 1140. The flowchart of FIG. 12B shows the details of step S150 shown in FIG. 12A.

In FIG. 12A, the non-CSG terminal device detector 1110 makes a decision as to whether or not the non-CSG terminal device 1030 exists in the coverage area of the CSG base station device 1010 (step S110). When the non-CSG terminal device detector 1110 determines that the non-CSG terminal device 1030 does not exist in the coverage area of the CSG base station device 1010 (i.e. “NO” in step S110), the non-CSG terminal device detector 1110 notifies the antenna transmission mode determination unit 1120, the scheduler mode determination unit 1130, and the OFDM symbol determination unit 1140 of a decision result (or a detection result) that the non-CSG terminal device 1030 does not exist in the coverage area of the CSG base station device 1010. In contrast, when the non-CSG terminal device detector 1110 determines that the non-CSG terminal device 1030 exists in the coverage area of the CSG base station device 1010 (i.e. “YES” in step S110), the non-CSG terminal device detector 1110 notifies the antenna transmission mode determination unit 1120, the scheduler mode determination unit 1130, and the OFDM symbol determination unit 1140 of a decision result (or a detection result) that the CSG terminal device 1030 exists in the coverage area of the CSG base station device 1010.

Upon receiving the decision result (i.e. “NO” in step S110) that the non-CSG terminal device 1030 does not exist in the coverage area of the CSG base station device 1010, the antenna transmission mode determination unit 1120 determines an antenna transmission mode based on the number of antennas installed in the CSG base station device 1010 (step S120). In contrast, upon receiving the decision result (i.e. “YES” in step S110) that the non-CSG terminal device 1030 exists in the coverage area of the CSG base station device 1010, the antenna transmission mode determination unit 1120 determines an antenna transmission mode based on existence or nonexistence of antenna information regarding the number of antennas installed in the macro-base station device 1020 (step S122).

Upon receiving the decision result (i.e. “NO” in step S110) that the non-CSG terminal device 1030 does not exist in the coverage area of the CSG base station device 1010, the scheduler mode determination unit 1130 selects a dynamic scheduler mode with respect to the CSG base station device 1010 (step S130). Upon receiving the decision result (i.e. “YES” in step S110) that the non-CSG terminal device 1030 exists in the coverage area of the CSG base station 1010, the scheduler mode determination unit 1130 selects a semi-persistent scheduler mode with respect to the CSG base station device 1010 (step 132).

Upon receiving the decision result (i.e. “NO” in step S110) that the non-CSG terminal device 1030 does not exist in the coverage area of the CSG base station device 1010, the OFDM symbol determination unit 1140 sets a non-zero number to the number of OFDM symbols used for PDCCH in the CSG base station device 1010 (step S140). Upon receiving the decision result (i.e. “YES” in step S110) that the non-CSG terminal device 1030 exists in the coverage area of the CSG base station device 1010, the OFDM symbol determination unit 1140 sets zero to the number of OFDM symbols used for PDCCH in the CSG base station device 1010.

Subsequent to step S140 or step S142, the scheduler mode determination unit 1130 and the OFDM symbol determination unit 1140 performs a timer process (see FIG. 12B); then, the CSG base station device 1010 exits the flowchart of FIG. 12A.

In FIG. 12B, the scheduler mode determination unit 1130 makes a decision as to whether or not the semi-persistent scheduler mode is currently selected as the scheduler mode (step S152). When the scheduler mode determination unit 1130 determines that the semi-persistent scheduler mode is not currently selected (i.e. “NO” in step S152), the CSG base station device 1010 exits the flowchart of FIG. 12B and then exits the flowchart of FIG. 12A.

When the scheduler mode determination unit 1130 determines that the semi-persistent scheduler mode is currently selected (i.e. “YES” in step S152), the scheduler mode determination unit 1130 makes a decision as to whether or not a predetermined time has elapsed from the timing of selecting the semi-persistent scheduler mode (step S154). When the scheduler mode determination unit 1130 determines that the predetermined time has not elapsed from the timing of selecting the semi-persistent scheduler mode (i.e. “NO” in step S154), the CSG base station device 1010 exits the flowchart of FIG. 12B and then exits the flowchart of FIG. 12A.

When the scheduler mode determination unit 1130 determines that the predetermined time has elapsed from the timing of selecting the semi-persistent scheduler mode (i.e. “YES” in step S154), the scheduler mode determination unit 1130 changes the semi-persistent scheduler mode with the dynamic scheduler mode (step S230). That is, the scheduler mode of the CSG base station device 1010 is changed from the semi-persistent scheduler mode to the dynamic scheduler mode. Thereafter, the OFDM symbol determination unit 1140 sets a non-zero number to the number of OFDM symbols used for PDCCH in the CSG base station device 1010 (step S240). That is, the OFDM symbol determination unit 1140 changes the number of OFDM symbols from zero to a non-zero number.

Subsequent to step S240, the scheduler mode determination unit 1130 selects the semi-persistent scheduler mode with respect to the CSG base station device 1010 (step S332). That is, the scheduler mode of the CSG base station device 1010 is changed from the dynamic scheduler mode to the semi-persistent scheduler mode. Subsequent to step S332, the OFDM symbol determination unit 1140 sets zero to the number of OFDM symbols used for PDCCH in the CSG base station device 1010 (step S342). That is, the number of OFDM symbols is changed from a non-zero number to zero. Thereafter, the CSG base station device 1010 exits the flowchart of FIG. 12B and then exits the flowchart of FIG. 12A.

It is possible to insert a further step, between step S240 and step S332 in FIG. 12B, in which the CSG terminal device detector 1110 makes a decision whether or not the non-CSG terminal device 1030 exists in the coverage area of the CSG base station device 1010. In this case, upon receiving the decision result that the non-CSG terminal device 1030 exists in the coverage area of the CSG base station device 1010, the scheduler mode determination unit 1130 carries out switching from the dynamic scheduler mode to the semi-persistent scheduler mode, whilst upon receiving the decision result that the non-CSG terminal device 1030 does not exist in the coverage area of the CSG base station device 1010, the scheduler mode determination unit 1130 maintains the dynamic scheduler mode. Additionally, upon receiving the decision result indicating the existence of the non-CSG terminal device 1030, the OFDM symbol determination unit 1140 changes the number of OFDM symbols from a non-zero number to zero, whilst upon receiving the decision result indicating the nonexistence of the non-CSG terminal device 1030, the OFDM symbol determination unit 1140 maintains the number of OFDM symbols at zero.

In this connection, it is possible to preclude step S150 (i.e. FIG. 12B) in the flowchart of FIG. 12A.

As described above, the present embodiment is able to prevent or reduce degradation of reception quality with physical control channels (e.g. RS, PCFICH, PDCCH) of non-CSG terminals even when non-CSG terminals, which are not allowed to communicate with the CSG base station device 1010, exists in the coverage area of the CSG base station device 1010.

The present embodiment refers to the CSG base station device 1010 shown in FIG. 10, which includes the non-CSG terminal device detector 1110, the antenna transmission mode determination unit 1120, the scheduler mode determination unit 1130, the OFDM symbol determination unit 1140, the RS generation unit 1150, the downlink/uplink data channel allocation unit 1160, the downlink control channel allocation unit 1162, the PDCCH generation unit 1164, the data channel generation unit 1166, and the PCFICH generation unit 1170; but this is not a restriction. In short, the CSG base station device 1010 can be simply configured of the non-CSG terminal device detector 1110, the antenna transmission mode determination unit 1120, the scheduler mode determination unit 1130, and the OFDM symbol determination unit 1140.

It is possible to store programs, implementing the processing of the CSG base station device 1010, in computer-readable recording media, wherein computer systems are allowed to load those programs of computer-readable recording media so as to implement the processing of the CSG base station device 1010 including the foregoing functions of the constituent elements. Herein, the term “computer system” may embrace both of software such as operating system (OS) and hardware such as peripheral devices. Additionally, the computer system may embrace WWW systems involving homepage providing environments (or homepage browsing environments). The term “computer-readable recording media” may embrace flexible disks, magnetooptic disks, ROM, non-volatile memory such as flash memory, portable media such as CD-ROM, and storage devices such as hard-disk units built in computer systems.

Additionally, computer-readable storage media further embrace any media temporarily retaining programs such as volatile memory (e.g. DRAM: Dynamic Random Access Memory) built in computer systems, which may act as servers and clients in accordance with programs transmitted via communication lines, e.g. telephone lines and networks (e.g. the Internet). Those programs can be transmitted from one computer system to another via carrier waves propagating through transmission media. Herein, the term “transmission media” may represent information transmittable media such as communication lines, e.g. telephone lines and networks (e.g. the Internet). In this connection, programs do not necessarily implement the entire functionality of the present embodiment but may implement a part of the functionality. Alternatively, programs may represent differential files which are combined with existing programs, pre-installed in computer systems, to achieve the entire functionality of the present embodiment.

### 3. Third Embodiment

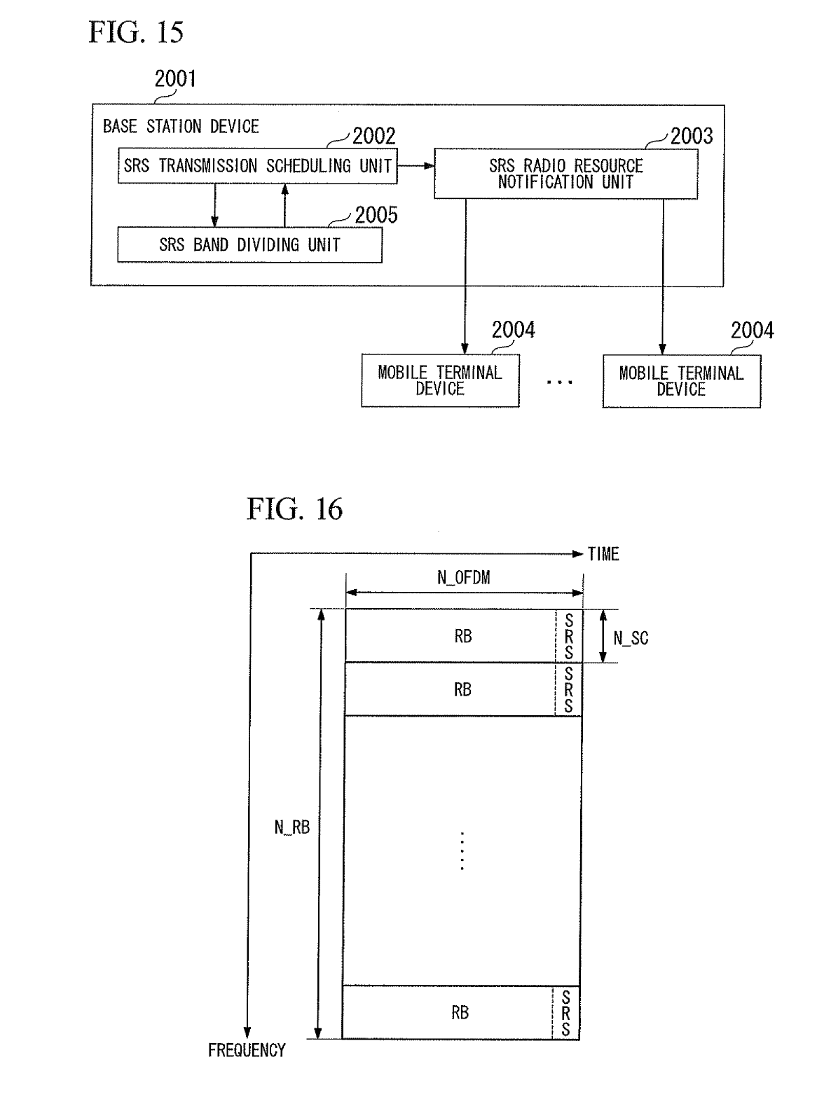

FIG. 15 is a block diagram of an OFDMA system according to a third embodiment of the present invention, wherein a base station device 2001 includes an SRS (Sounding Reference Signal) transmission scheduling unit 2002, an SRS radio resource notification unit 2003, and an SRS band dividing unit 2005.

The SRS transmission scheduling unit 2002 allocates radio resources, used for uplink SRS transmission, to mobile terminal devices 2004 which visit the coverage area of the base station device 2001. The SRS radio resource notification unit 2003 notifies the mobile terminal devices 2004 of SRS transmission radio resources. The SRS band dividing unit 2005 divides already allocated SRS radio resources so as to secure vacancy of SRS radio resources when no surplus SRS radio resources remain when mobile terminal devices 2004 need SRS radio resources newly allocated thereto.

FIG. 16 is an illustration of a partial configuration of uplink radio resources in the OFDMA system, wherein a time direction corresponds to one unit of SRS transmission whilst a frequency direction corresponds to a system frequency band. FIG. 16 shows a plurality of resource blocks (RB), the number of which is set to N_RB, is vertically aligned and connected in the frequency direction. Each resource block is defined with a specific frequency bandwidth (corresponding to the number of subcarriers, N_SC) and a specific time length (corresponding to the number of OFDM symbols, N_OFDM). The total of the frequency bandwidths of the N_RB resource blocks (RB) corresponds to the system frequency band. Sounding reference signals (SRS) of reference blocks (RB) subjected to SRS transmission are each transmitted with a last OFDM symbol with respect to time.

SRS radio resources adopted in the present embodiment will be described in detail. SRS radio resources are defined using SRS bandwidths, SRS transmission intervals, SRS band offsets, SRS transmission timing offsets, cyclic shifts, and transmission combs.

The SRS transmission bandwidth is a frequency bandwidth of each SRS, which is measured in units of resource blocks (RB). Since the present embodiment is designed with the system frequency band of 10 MHz (corresponding to 48 RB), it is possible to provide six candidates as SRS bandwidths, i.e. 4, 8, 12, 16, 24, and 48 in units of RB. It is possible to limit combinations of selectable candidates of SRS bandwidths. For instance, it is possible to provide combinations of selectable candidates of SRS bandwidths, e.g. “4, 12, 24, 48” and “4, 8, 16, 48”. In this connection, an operator may designate an appropriate combination of selectable candidates of SRS bandwidths.

The SRS transmission interval is a time interval allowing one mobile terminal device 2004 to transmit a sounding reference signal (SRS). In the present embodiment, the SRS transmission interval (indicating a unit time corresponding to the number N_OFDM of OFDM symbols) is determined in units of milliseconds, wherein it is possible to provide eight candidates as SRS transmission intervals, i.e. 2, 5, 10, 20, 40, 80, 160, and 320 in units of milliseconds. The present embodiment fixedly employs one candidate of SRS transmission interval. In this connection, an operator may designate an appropriate SRS transmission interval; or it is possible to automatically designate an appropriate SRS transmission interval.

The SRS band offset designates an SRS band at the start timing of SRS transmission, wherein the SRS band offset is determined in units of SRS bandwidths and provided to the mobile terminal devices 2004 involved in SRS transmission using the same SRS band. The SRS band offset allows the mobile terminal devices 2004, involved in simultaneous SRS transmission, to transmit sounding reference signals (SRS) by shifting their SRS bands.

The SRS transmission timing offset designates the start timing of SRS transmission, wherein the present embodiment sets the SRS transmission timing offset ranging from 0 to “SRS transmission interval −1” in units of milliseconds. The SRS transmission timing offset allows the mobile terminal devices 2004, involved in SRS transmission using the same SRS band, to transmit sounding reference signals (SRS) by shifting their transmission timings.

Each sounding reference signal (SRS) has specific amplitude on the time axis and the frequency axis, wherein it is possible to utilize a series of codes which are cyclic-shifted and orthogonally aligned, e.g. Zadoff-Chu series. Owing to cyclic shifting, it is possible to prevent interference occurring between the mobile terminal devices 2004 involved in SRS transmission with the same SRS band at the same timing. However, cyclic shifting cannot produce an interference preventive effect with respect to the mobile terminal devices 2004 having different SRS bandwidths. In this case, a transmission comb is used instead of cyclic shifting.

The transmission comb designates subcarriers used for SRS transmission. In the present embodiment, each mobile terminal device 2004 is allowed to perform SRS transmission using every other subcarrier. That is, SRS transmission is performed using even-numbered subcarriers or odd-numbered subcarriers. For this reason, the present embodiment may prepare two types of transmission combs designating even-numbered subcarriers and odd-numbered subcarriers for use in SRS transmission. Using the transmission comb, it is possible to prevent interference occurred between the mobile terminal devices 2004 involved in SRS transmission with the same SRS band at the same timing. In this connection, the mobile terminal devices 2004 having different SRS bandwidths, involved in SRS transmission with the same SRS band at the same timing, take precedence in using the transmission comb.

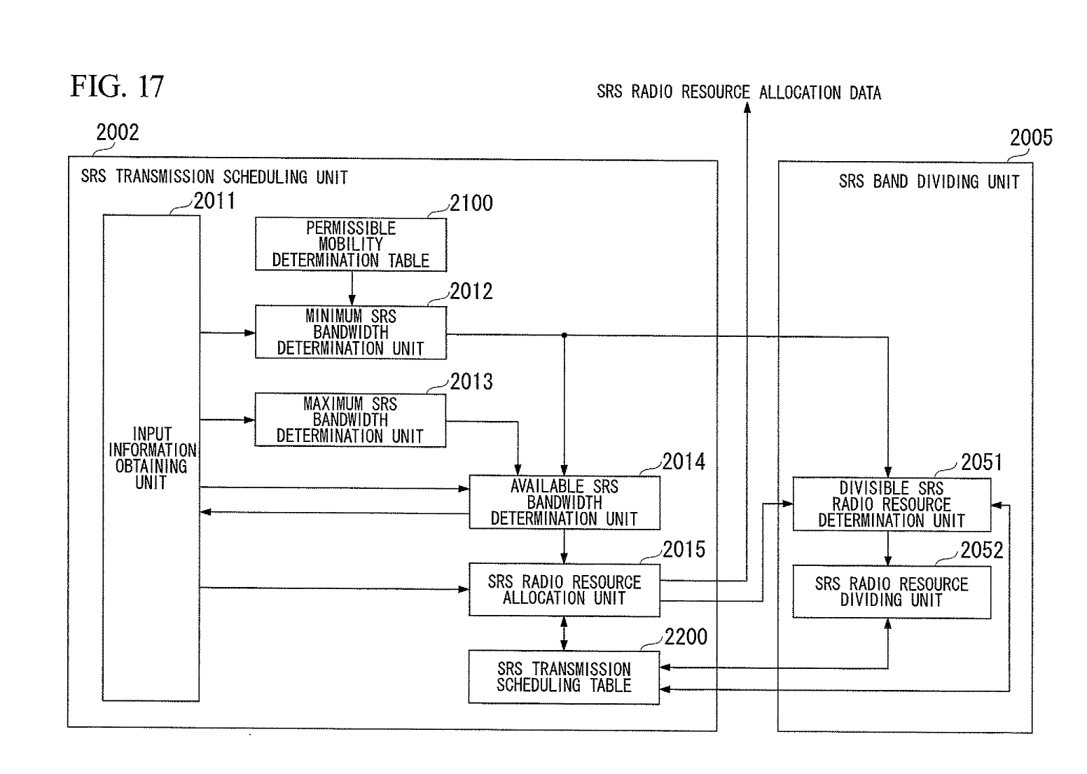

FIG. 17 is a block diagram showing the details of the SRS transmission scheduling unit 2002 and the SRS band dividing unit 2005. The SRS transmission scheduling unit 2002 includes an input information obtaining unit 2011, a minimum SRS bandwidth determination unit 2012, a maximum SRS bandwidth determination unit 2013, an available bandwidth determination unit 2014, an SRS radio resource allocation unit 2015, a permissible mobility decision table 2100, and an SRS transmission scheduling table 2200.

The input information obtaining unit 2011 obtains various pieces of input information. As input information, it possible to name a start trigger of an SRS transmission scheduling process, terminal numbers of all mobile terminal devices 2004 allocated with SRS radio resources, priority levels of allocating SRS radio resources to mobile terminal devices 2004, combinations of selectable candidates of SRS bandwidths, SRS transmission intervals, maximum transmission power of mobile terminal devices 2004, and mobility of mobile terminal devices 2004.

The minimum SRS bandwidth determination unit 2012 determines a minimum value of an SRS bandwidth based on mobility of the mobile terminal device 2004. The maximum SRS bandwidth determination unit 2013 determines a maximum value of an SRS bandwidth based on maximum transmission power of the mobile terminal device 2004. The available SRS bandwidth determination unit 2014 determines a range of available SRS bandwidths in the mobile terminal device 2004 based on the minimum value of the SRS bandwidth determined by the minimum SRS bandwidth determination unit 2012 and the maximum value of the SRS bandwidth determined by the maximum SRS bandwidth determination unit 2013. Based on the range of available SRS bandwidths in the mobile terminal device 2004, the SRS radio resource allocation unit 2015 determines an appropriate SRS bandwidth of the mobile terminal device 2004, thus allocating SRS radio resources to the mobile terminal device 2004.

The permissible mobility determination table 2100 stores data used for determining mobility with respect to a combination of an SRS transmission interval and an SRS bandwidth.

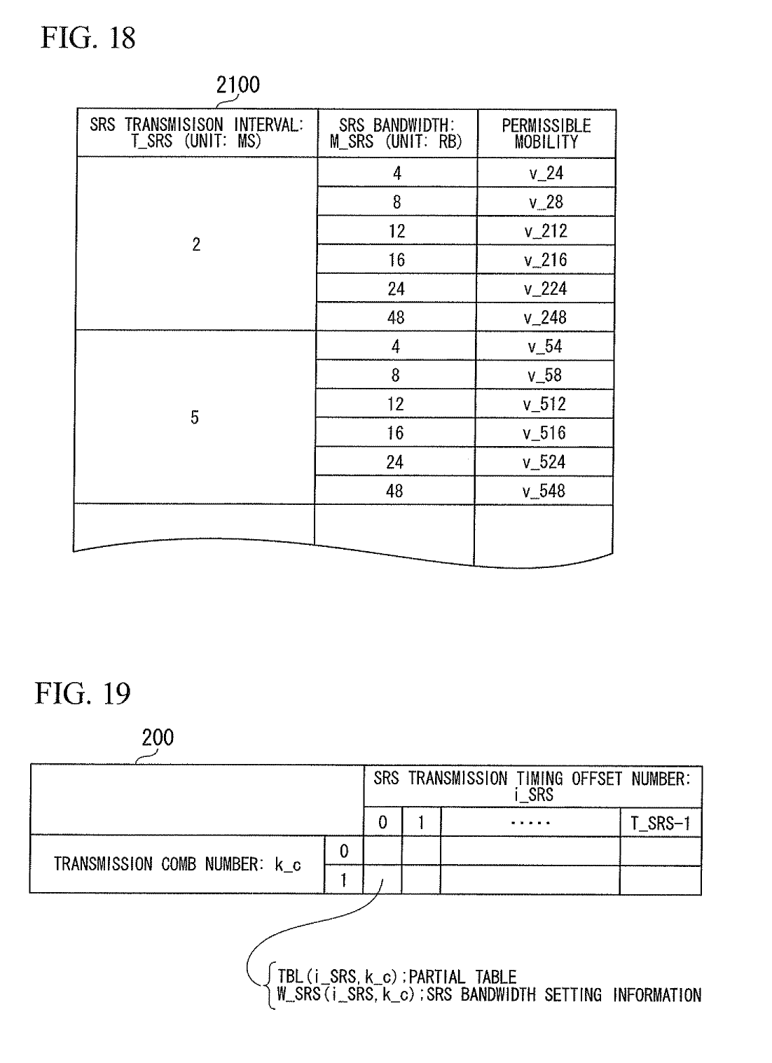

FIG. 18 shows an example of the permissible mobility determination table 2100, which describes permissible mobility per each combination of the SRS transmission interval (T_SRS in units of milliseconds) and the SRS bandwidth (M_SRS in units of RB). With reference to the permissible mobility determination table 2100, it is possible to determine maximum mobility of the mobile terminal device 2004 adopting the combination of the SRS transmission interval and the SRS bandwidth. For example, a combination of “T_SRS=2, M_SRS=4” reads up to mobility of “v_{—}24” adaptable to the mobile terminal device 2004.

Since the present embodiment employs the fixed value of the SRS transmission interval, it is possible to determine a minimum value of an SRS bandwidth applicable to the mobile terminal device 2004 at a certain value of mobility with reference to the permissible mobility determination table 2100. The minimum SRS bandwidth determination unit 2012 determines the minimum value of the SRS bandwidth applicable to the mobile terminal device 2004 at a certain value of mobility with reference to the permissible mobility determination table 2100.

Next, a method of creating the permissible mobility determination table 2100 will be described below.

Since SRS transmission aims to obtain frequency characteristics in the entire system frequency range, a time required to obtain frequency characteristics in the entire system frequency range (simply referred to as a turnaround time of obtaining frequency characteristics) entails a certain restriction equivalent to mobility of the mobile terminal device 2004. As mobility increases, the mobile terminal device 2004 undergoes an increasingly rapid variation of a radio environment; hence, the turnaround time of obtaining frequency characteristics needs to be shortened to track a radio environment variation. That is, the turnaround time of obtaining frequency characteristics needs to be completed within a coherence time. The coherence time should be sufficiently shorter than a Doppler period depending upon mobility of the mobile terminal device 2004.

An SRS transmission frequency required to obtain frequency characteristics in the entire system frequency range is determined depending upon each SRS bandwidth. For instance, an SRS bandwidth “M_SRS=4” requires an SRS transmission frequency of “48/4=12” to obtain frequency characteristics of the entire system frequency range (i.e. 48 RB). Additionally, a time required to accomplish the SRS transmission frequency is determined depending upon each SRS transmission interval.

For instance, an SRS transmission interval of “T_SRS=2” combined with an SRS bandwidth “M_SRS=4” requires “2×12−1=23 (ms)” from the first transmission to the last transmission. Thus, a turnaround time of obtaining frequency characteristics is determined depending upon each combination of an SRS transmission interval and an SRS bandwidth.

As described above, permissible mobility per each combination of an SRS transmission interval and an SRS bandwidth is determined in relation to a restriction of the turnaround time of obtaining frequency characteristics owing to mobility and a restriction of the turnaround time of obtaining frequency characteristics depending upon each combination of an SRS transmission interval and an SRS bandwidth.

Normally, a certain time deviation occurs between the timing of allocating SRS radio resources and the actual timing of SRS transmission; hence, it is preferable to determine a restriction of the turnaround time of obtaining frequency characteristics in light of this time deviation.

The present embodiment is designed to create the permissible mobility determination table 2100 in advance and install it in the SRS transmission scheduling unit 2002; but this is not a restriction. It is possible to modify the SRS transmission scheduling unit 2002 in such a way that an appropriate coherence time is produced based on mobility of the mobile terminal device 2004, thus determining a minimum value of an SRS bandwidth at a specific SRS transmission interval on condition that the turnaround time of obtaining frequency characteristics falls within the coherence time.

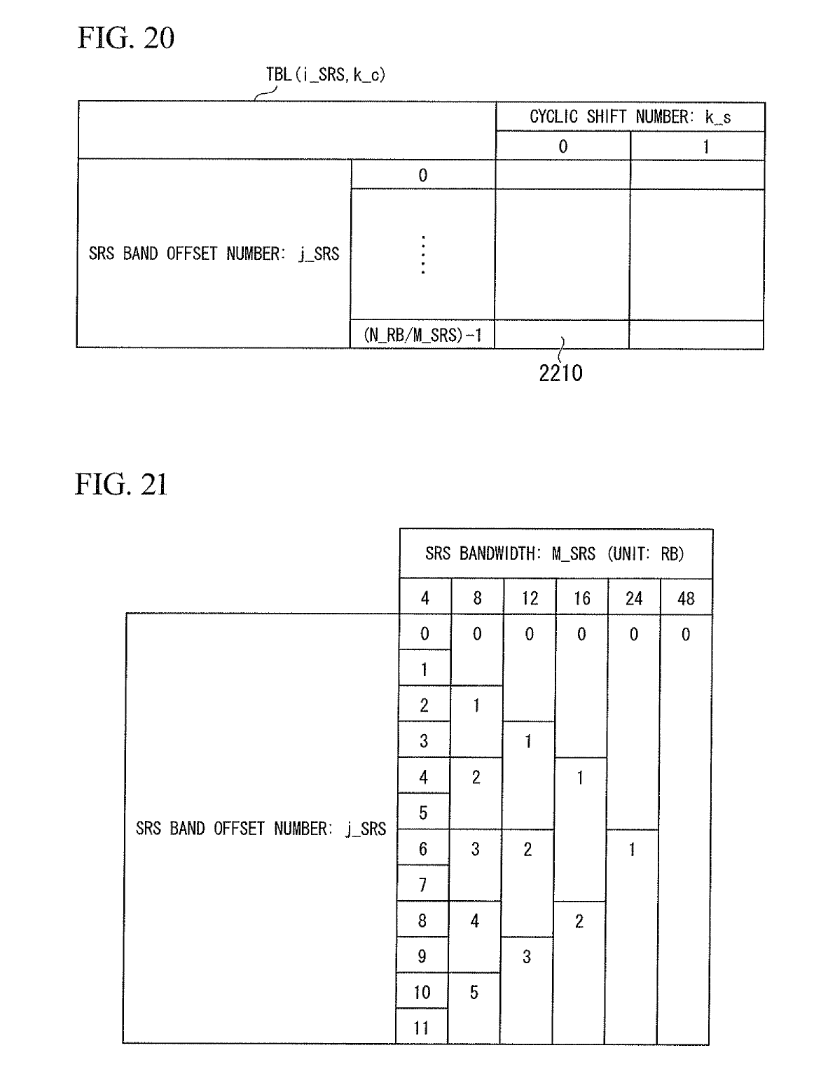

Referring back to FIG. 17, the SRS transmission scheduling table 2200 stores allocation results of SRS radio resources. The SRS transmission scheduling table 2200 stores allocation results of SRS radio resources. FIGS. 19 and 20 show exemplary contents of the SRS transmission scheduling table 2200. Specifically, FIG. 19 shows the entire content of the SRS transmission scheduling table 2200, and FIG. 20 shows a partial table TBL(i_SRS,k_c) included in the SRS transmission scheduling table 2200.

The SRS transmission scheduling table 2200 of FIG. 19 stores the partial table TBL(i_SRS,k_c) and SRS bandwidth setting information W_SRS(i_SRS,k_c) per each combination of an SRS transmission offset number (i_SRS) and a transmission comb number (k_c).

The SRS transmission timing offset number (i_SRS) identifies an SRS transmission timing offset, which ranges from zero to “SRS transmission interval (T_SRS)−1” in units of milliseconds; hence, the SRS transmission timing offset number (i_SRS) increments one by one in the range from zero to “(T_SRS)−1”.

The transmission comb number (k_c) identifies the type of a transmission comb. The present embodiments provides two types of transmission combs identifies by respective numbers, i.e. “k_c=0” indicating SRS transmission using even-numbered subcarriers and “k_c=1” indicating SRS transmission using odd-numbered subcarriers.

The SRS bandwidth setting information W_SRS(i_SRS,k_c) indicates an SRS transmission bandwidth which is determined per each combination of the SRS transmission timing offset number (i_SRS) and the transmission comb number (k_c). The partial table TBL(i_SRS,k_c) represents an SRS bandwidth indicated by the SRS bandwidth setting information W_SRS(i_SRS,k_c) with respect to the combination (i_SRS,k_c).

As shown in FIG. 20, the partial table TBL(i_SRS,k_c) describes an allocated terminal number 2210 per each combination of an SRS band offset number (j_SRS) and a cyclic shift number (k_c). The SRS band offset number (j_SRS) identifies an SRS band offset which is measured in units of SRS bandwidths.

FIG. 21 shows a correspondence relationship between an SRS bandwidth (M_SRS) and the SRS band offset number (j_SRS). Regarding the SRS bandwidth “M_SRS=4”, the SRS band offset number (j_SRS) increments one by one in a range from 0 to 11, each of which represents an offset value counted in units of 4 RB. Regarding the SRS bandwidth “M_SRS=8”, the SRS band offset number (j_SRS) increments one by one in a range from 0 to 5, each of which represents an offset value counted in units of 8 RB. Regarding the SRS bandwidth “M_SRS=12”, the SRS band offset number (j_SRS) increments one by one in a range from 0 to 3, each of which represents an offset value counted in units of 12 RB. Regarding the SRS bandwidth “M_SRS=16”, the SRS band offset number (j_SRS) increments one by one in a range from 0 to 2, each of which represents an offset value counted in units of 16 RB. Regarding the SRS bandwidth “M_SRS=24”, the SRS band offset number (j_SRS) changes between 0 and 1, each of which represents an offset value counted in units of 24 RB. Regarding the SRS bandwidth “M_SRS=48”, the SRS band offset number (j_SRS) is set to 0 representing an offset value of 48 RB.

Referring back to FIG. 20, a cyclic shift number (k_s) identifies the type of a cyclic shift. The present embodiment provides two types of cyclic shifts respectively corresponding to cyclic shift numbers 0 and 1. The allocated terminal number 2210 identifies each mobile terminal device 2004 allocated with a combination of SRS radio resources (including the SRS bandwidth, SRS transmission timing offset, SRS band offset, cyclic shift, and transmission comb).

Referring back to FIG. 17, the SRS radio resource allocation unit 2015 stores allocation results of SRS radio resources in the SRS transmission scheduling table 2200. Additionally, the SRS radio resource allocation unit 2015 reads allocation results of SRS radio resources from the SRS transmission scheduling table 2200 so as to provide SRS radio resource allocation data to the SRS radio resource notification unit 2003. SRS radio resource allocation data includes the SRS transmission interval (which is shared by all the mobile terminal devices 2004) and a combination of SRS radio resources allocated to each mobile terminal device 2004, i.e. a combination of the SRS bandwidth, SRS transmission timing offset, SRS band offset, cyclic shift, and transmission comb which is denoted by “M_SRS,i_SRS,j_SRS,k_s,K_c”.

The SRS band dividing unit 2005 includes a divisible SRS radio resource determination unit 2051 and an SRS radio resource dividing unit 2052. Upon receiving a notification that the SRS radio resource allocation unit 2015 fails to allocate the partial table TBL(i_SRS,k_c) with respect any one of available SRS bandwidths (M_SRS) relating to the selected mobile terminal device 2004, the divisible SRS radio resource determination unit 2051 makes a decision as to whether or not the SRS transmission scheduling table 2200 describes an allocation result of SRS radio resources with a divisible SRS bandwidth (M_SRS) among allocation results of SRS radio resources therein. When an allocation result of SRS radio resources with a divisible SRS bandwidth (M_SRS) is found, the divisible SRS radio resource determination unit 2051 notifies the found allocation result to the SRS radio resource dividing unit 2052. The SRS radio resource dividing unit 2052 divides the allocation result of SRS radio resources notified by the divisible SRS radio resource determination unit 2051.

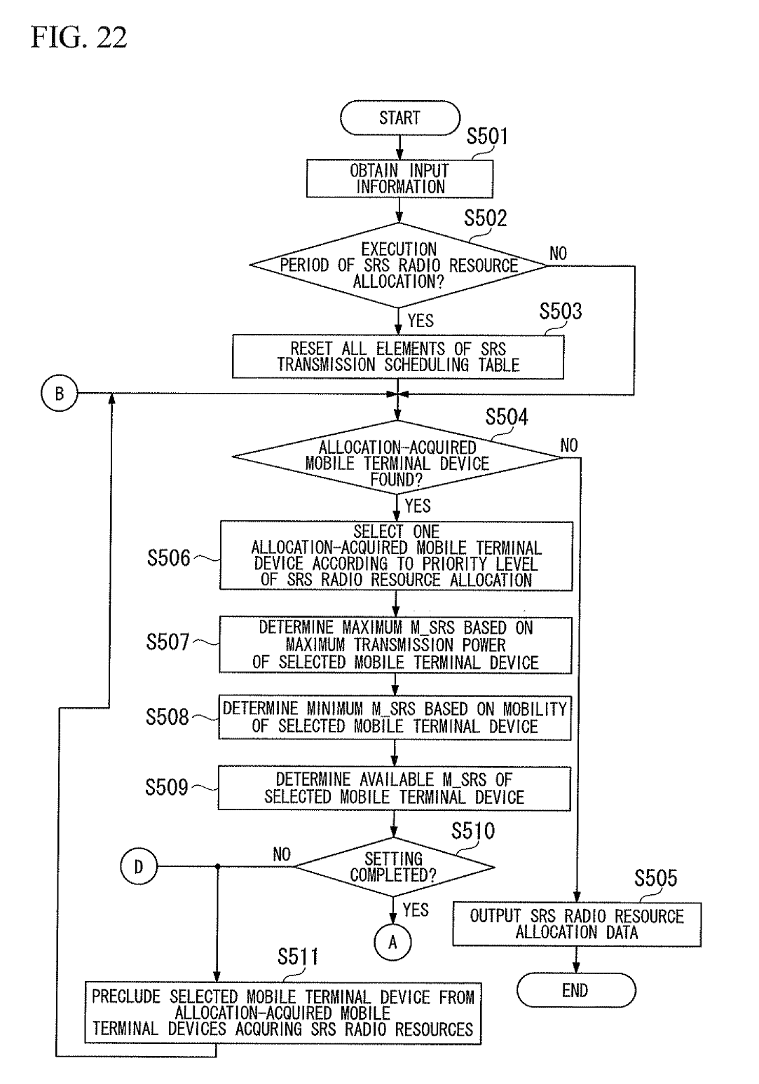

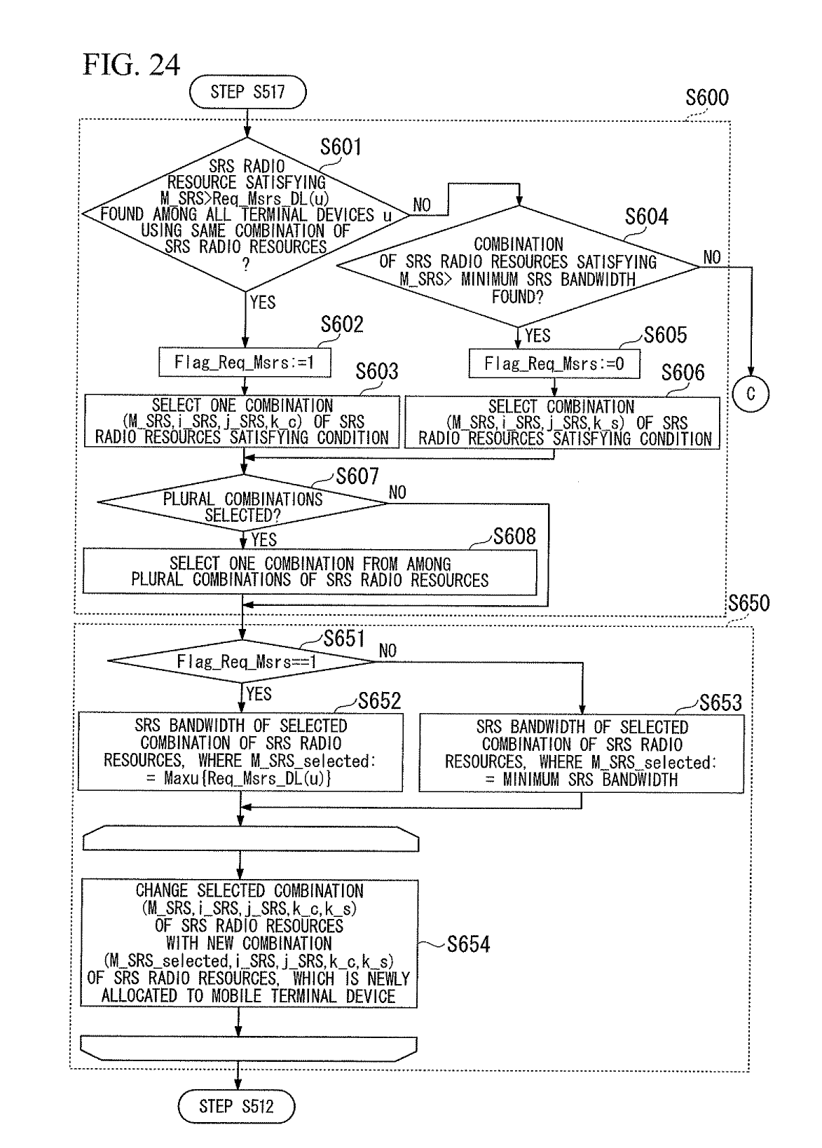

Next, the operation of the SRS transmission scheduling unit 2002 will be described with reference to FIGS. 22, 23, 24, and 25. FIGS. 22 to 25 are flowcharts illustrating procedures of SRS transmission scheduling. Herein, FIG. 24 shows details of steps S600 and S650.

The SRS transmission scheduling unit 2002 starts SRS transmission scheduling when triggered by a specific event, which is driven by either an execution period of SRS radio resource allocation or the mobile terminal device 2004 newly visiting the coverage area of the base station device 2001.

When SRS transmission scheduling is started, the flow firstly proceeds to step S501 in FIG. 22, in which the input information obtaining unit 2011 obtains input information. In step S502, the input information obtaining unit 2011 makes a decision as to whether or not SRS transmission scheduling is triggered to start in relation to an execution period of SRS radio resource allocation. When it is determined that SRS transmission scheduling is triggered to start in relation to the execution period of SRS radio resource allocation, the input information obtaining unit 2011 instructs the SRS radio resource allocation unit 2015 to reset the SRS transmission scheduling table 2200. Thus, the SRS radio resource allocation unit 2015 resets the entire content of the SRS transmission scheduling table 2200 in step S503; then, the flow proceeds to step S504. When it is determined that SRS transmission scheduling is not triggered to start in relation to the execution period of SRS radio resource allocation, in other words, when it is determined that SRS transmission scheduling is triggered to start in relation to the mobile terminal device 2004 newly visiting the coverage area of the base station device 2001, the SRS radio resource allocation unit 2015 does not reset the content of the SRS transmission scheduling table 2200; then, the flow directly proceeds to step S504.

In step S504, the input information obtaining unit 2011 makes a decision as to whether or not the base station device 2001 senses an allocation-acquired mobile terminal device that needs to acquire SRS radio resources. When the base station device 2001 senses an allocation-acquired mobile terminal device, the flow proceeds to step S506. When the base station device 2001 senses any allocation-acquired mobile terminal device, the input information obtaining unit 2011 instructs the SRS radio resource allocation unit 2015 to output SRS radio resource allocation data in step S505. Thus, the SRS radio resource allocation unit 2015 produces SRS radio resource allocation data in accordance with the content of the SRS transmission scheduling table 2200, thus outputting SRS radio resource allocation data to the SRS radio resource notification unit 2003.

In step S506, the input information obtaining unit 2011 selects one of allocation-acquired mobile terminal devices in accordance with its priority level of SRS radio resource allocation.

In step S507, the input information obtaining unit 2011 notifies the maximum SRS bandwidth determination unit 2013 of the maximum transmission power of the selected mobile terminal device which is selected in accordance with its priority level, thus instructing the maximum SRS bandwidth determination unit 2013 to calculate a maximum value of an SRS bandwidth (M_SRS) with regard to the selected mobile terminal device. Based on the maximum transmission power notified by the input information obtaining unit 2011, the maximum SRS bandwidth determination unit 2013 produces the maximum value of the SRS bandwidth (M_SRS) with regard to the selected mobile terminal device. Since each mobile terminal device 2004 is limited in its transmission power, the maximum SRS bandwidth determination unit 2013 is able to determine the maximum value of the SRS bandwidth (M_SRS) based on the maximum transmission power of each mobile terminal device 2004. Then, the maximum SRS bandwidth determination unit 2013 notifies the available SRS bandwidth determination unit 2014 of the maximum value of the SRS bandwidth (M_SRS) with regard to the selected mobile terminal device.

In step S508, the input information obtaining unit 2011 notifies the minimum SRS bandwidth determination unit 2012 of the SRS transmission interval (T_SRS) and mobility of the selected mobile terminal device, thus instructing the minimum SRS bandwidth determination unit 2012 to calculate a minimum value of an SRS bandwidth (M_SRS) with regard to the selected mobile terminal device. Based on the SRS transmission interval (T_SRS) and mobility of the selected mobile terminal device notified by the input information obtaining unit 2011, the minimum SRS bandwidth determination unit 2012 produces the minimum value of the SRS bandwidth (M_SRS) with regard to the selected mobile terminal device. Specifically, the minimum SRS bandwidth determination unit 2012 the minimum value of the SRS bandwidth (M_SRS), which is permissible in the SRS transmission interval (T_SRS), with reference to the permissible mobility determination table 2100. Then, the minimum SRS bandwidth determination unit 2012 notifies the available SRS bandwidth determination unit 2014 of the minimum value of the SRS bandwidth (M_SRS) with regard to the selected mobile terminal device.

In step S509, the input information obtaining unit 2011 notifies the available SRS bandwidth determination unit 2014 of a combination of selectable candidates of SRS bandwidths (M_SRS), thus instructing the available SRS bandwidth determination unit 2014 to determine a range of available SRS bandwidths (M_SRS) with regard to the selected mobile terminal device. Based on the minimum value and the maximum value of the SRS bandwidth (M_SRS), the available SRS bandwidth determination unit 2014 determines the range of available SRS bandwidths (M_SRS) with regard to the selected mobile terminal device in light of the combination of selectable candidates of SRS bandwidth (M_SRS) notified by the input information obtaining unit 2011. The available range of the SRS bandwidth (M_SRS) is determined based on the following conditions.
(i) The minimum value of the SRS bandwidth (M_SRS)≦the maximum value of the SRS bandwidth (M_SRS).
(ii) A selectable candidate of an available SRS bandwidth (M_SRS) exists in the range between the minimum value and the maximum value of the SRS bandwidth (M_SRS).

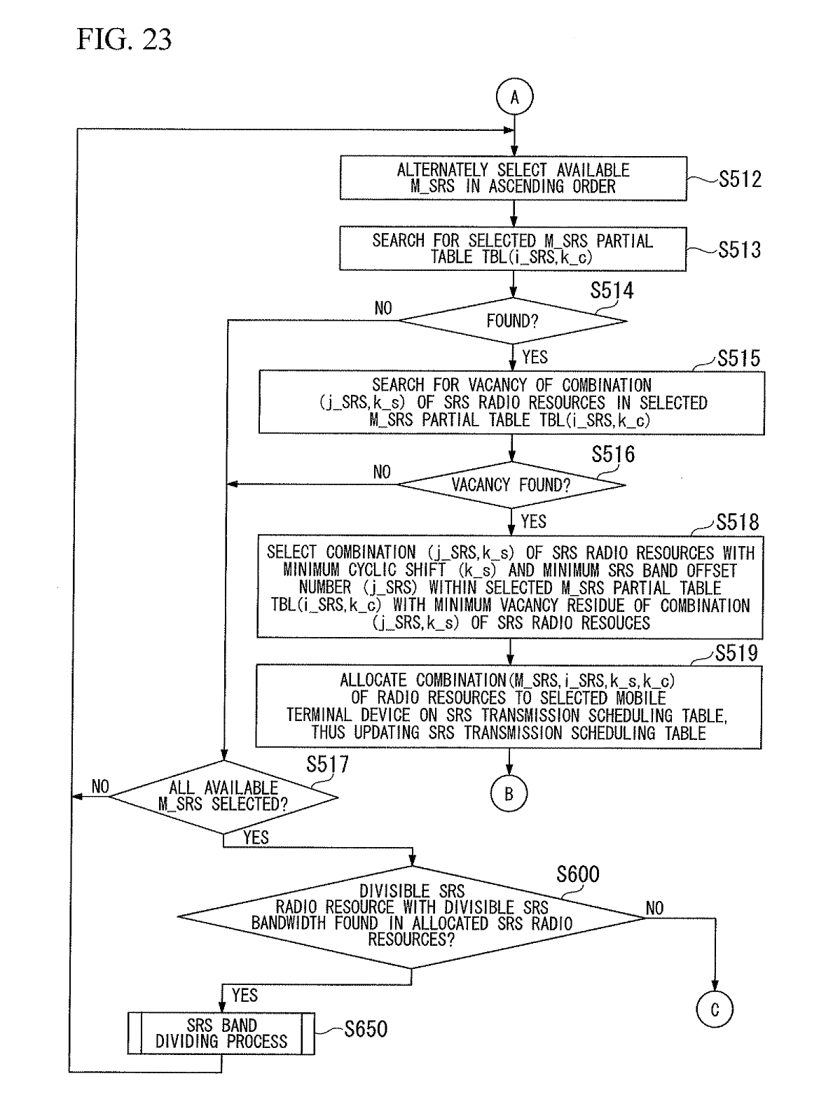

In step S510, a decision is made as to whether or not the available SRS bandwidth determination unit 2014 can determine the range of available SRS bandwidths (M_SRS) with regard to the selected mobile terminal device. In an event that the available SRS bandwidth determination unit 2014 succeeds to determine the range of available SRS bandwidths (M_SRS) with regard to the selected mobile terminal device, the available SRS bandwidth determination unit 2014 notifies the SRS radio resource allocation unit 2015 of all the selectable candidates of SRS bandwidths (M_SRS) which exist in the range between the minimum value and the maximum value of the SRS bandwidth (M_SRS). Those selectable candidates of SRS bandwidths (M_SRS), notified by the available SRS bandwidth determination unit 2014, are regarded as available SRS bandwidths (M_SRS) with regard to the selected mobile terminal device. Additionally, the available SRS bandwidth determination unit 2014 notifies the input information obtaining unit 2011 of a setting-complete message stating that the available SRS bandwidth determination unit 2014 succeeds to determine the range of available SRS bandwidths (M_SRS) with respect to the selected mobile terminal device. Thus, the input information obtaining unit 2011 notifies the SRS radio resource allocation unit 2015 of an identification number of the selected mobile terminal device, thus instructing allocation of SRS radio resources to the selected mobile terminal. Thereafter, the flow proceeds to step S512 shown in FIG. 23.

In an event that the available SRS bandwidth determination unit 2014 fails to determine the range of available SRS bandwidths (M_SRS), the available SRS bandwidth determination unit 2014 notifies the input information obtaining unit 2011 of a setting-incomplete message. Then, the flow proceeds to step S511 in which the input information obtaining unit 2011 precludes the selected mobile terminal device from allocation-acquired mobile terminal devices acquiring SRS radio resources. Thereafter, the flow returns to step S504.

In step S512 shown in FIG. 23, the SRS radio resource allocation unit 2015 alternately selects available SRS bandwidths (M_SRS) in ascending order, from smaller SRS bandwidths to larger SRS bandwidths, with regard to the selected mobile terminal device. Hereinafter, the finally selected available SRS bandwidth (M_SRS) will be referred to as selected M_SRS. The reason why the SRS radio resource allocation unit 2015 alternately selects available SRS bandwidths (M_SRS) in ascending order is to adopt an available SRS bandwidth as small as possible, thus seeking a probability of increasing the number of mobile terminal devices conducting SRS transmission.

In step S513, the SRS radio resource allocation unit 2015 searches for the partial table TBL(i_SRS,k_c) dedicated to the selected M_SRS in the SRS transmission scheduling table 2200. Specifically, the SRS radio resource allocation unit 2015 searches for a combination (i_SRS,k_c) of the SRS transmission timing offset number (i_SRS) and the transmission comb number (k_c) together with the SRS bandwidth setting information W_SRS(i_SRS,k_c) involving the selected M_SRS on the SRS transmission scheduling table 2200. Herein, the partial table TBL(i_SRS,k_c) relating to the combination (i_SRS,k_c) together with the SRS bandwidth setting information W_SRS(i_SRS,k_c) involving the selected M_SRS is denoted as selected M_SRS partial table TBL(i_SRS,k_c).

In step S514, the SRS radio resource allocation unit 2015 makes a decision as to whether or not the selected M_SRS partial table TBL(i_SRS,k_c) is found in the SRS transmission scheduling table 2200. When the selected M_SRS partial table TBL(i_SRS,k_c) is found, the flow proceeds to step S515. When the selected M_SRS partial table TBL(i_SRS,k_c) is not found, the flow proceeds to step S517.

In step S515, the SRS radio resource allocation unit 2015 searches for a vacancy in the combination (j_SRS,k_s) of SRS radio resources in the selected M_SRS partial table TBL(i_SRS,k_c). In step S516, the SRS radio resource allocation unit 2015 makes a decision as to whether or not a vacancy of the combination (j_SRS,k_s) of radio resources is found in the selected M_SRS partial table TBL(i_SRS,k_c). When no vacancy of the combination (j_SRS,k_s) of SRS radio resources is found in all the selected M_SRS partial tables TBL(i_SRS,k_c), the flow proceeds to step S517. When a vacancy of the combination (j_SRS,k_s) of SRS radio resources is found in at least one selected M_SRS partial table TBL(i_SRS,k_c), the flow proceeds to step S518.

In step S517, a decision is made as to whether or not the SRS radio resource allocation unit 2015 has selected all the available SRS bandwidths (M_SRS) with regard to the selected mobile terminal device. When the SRS radio resource allocation unit 2015 has completely selected all the available SRS bandwidths (M_SRS) with regard to the selected mobile terminal device, the flow proceeds to step S600. In contrast, at least one of available SRS bandwidths (M_SRS) relating to the selected terminal device remains unselected, the flow returns to step S512.

In step S518, the SRS radio resource allocation unit 2015 searches through the selected M_SRS partial table TBL(i_SRS,k_c), including the minimum vacancy residue of the combination (j_SRS,k_s) of SRS radio resources, so as to select the combination (j_SRS,k_s) of SRS radio resources with the minimum cyclic shift (k_s) and the minimum SRS band offset number (j_SRS). This leaves as many unused cyclic shifts as possible. Unused cyclic shifts may contribute to effective utilization of radio resources because of a probability that unused cyclic shifts can be used for data transmission other than SRS transmission.

In step S519, the SRS radio resource allocation unit 2015 describes the identification number of the selected mobile terminal device as the allocated terminal number 2210 in the column of the combination (j_SRS,k_s) of SRS radio resources in the selected M_SRS partial table TBL(i_SRS,k_c) which is selected in step S518. Thus, it is possible to allocate the combination (selected M_SRS, i_SRS, j_SRS, k_s, k_c), corresponding to the combination (j_SRS,k_s) of SRS radio resources in the selected M_SRS partial table TBL(i_SRS,k_c), to the selected mobile terminal device. Thereafter, the flow returns to step S504 shown in FIG. 22.

The flow proceeds to step S600 when the partial table TBL(i_SRS,k_c) is not allocated to any one of available SRS bandwidths with regard to the selected mobile terminal device, in other words, when the partial table TBL(i_SRS,k_c) of SRS radio resources cannot be allocated to the selected mobile terminal device. In this case, the divisible SRS radio resource determination unit 2051 makes a decision as to whether or not already allocated SRS radio resources include divisible SRS radio resources with divisible SRS bandwidths (M_SRS). The SRS radio resource dividing unit 2052 divides SRS bandwidths of divisible SRS radio resources so as to provide unoccupied SRS radio resources allocable to the selected mobile terminal device. In this connection, step S600 includes steps S601 to S608, whilst step S650 includes steps S651 to S654 shown in FIG. 24.

In step S601 shown in FIG. 24, upon receiving a message that the SRS radio resource allocation unit 2015 has selected all the available SRS bandwidths (M_SRS) with regard to the selected mobile station device, the divisible SRS radio resource determination unit 2051 searches for an allocation result of SRS radio resources satisfying the following condition among allocation results of SRS radio resources stored in the SRS transmission scheduling table 2200. This condition stipulates that an SRS bandwidth (M_SRS) should be larger than the minimum value of the SRS bandwidth which the minimum SRS bandwidth determination unit 2012 determines among all the mobile terminal devices 2004 conducting SRS transmission using the same SRS radio resources. Herein, the same SRS radio resources belong to the same combination (M_SRS,i_SRS,j_SRS,k_c) of SRS radio resources irrespective of the cyclic shift (k_s).

The following description is made such that the minimum SRS bandwidth determination unit 512 determines the mobile terminal device 2004(u) with its minimum SRS bandwidth, which will be referred to as a desired SRS bandwidth Req_Msrs_DL(u).

The flow proceeds to step S602 when the currently allocated SRS bandwidth (M_SRS) is larger than the desired SRS bandwidths Req_Msrs_DL(u) attributed to all the mobile terminal devices 2004(u). In contrast, the flow proceeds to step S604 when the currently allocated SRS bandwidth (M_SRS) is not larger than the desired SRS bandwidths Req_Msrs_DL(u) attributed to all the mobile terminal devices 2004(u).

In step S602, the divisible SRS radio resource determination unit 2051 sets “1” to a flag Flag_req_Msrs. In step S603, the divisible SRS radio resource determination unit 2051 selects divisible SRS radio resources with divisible SRS bandwidths (M_SRS), i.e. a combination (M_SRS,i_SRS,j_SRS,k_c) of SRS radio resources with SRS bandwidths (M_SRS) which are larger than the desired SRS bandwidth Req_Msrs_DL(u) of the mobile terminal device 2004(u). Then, the flow proceeds to step S607.

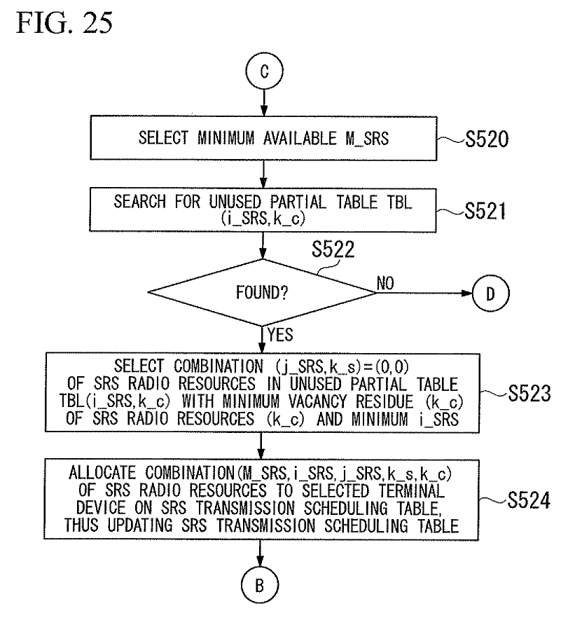

In step S604, the divisible SRS radio resource determination unit 2051 makes a decision as to whether or not allocation results of SRS radio resources include a combination (M_SRS,i_SRS,j_SRS,k_c) of SRS radio resources with SRS bandwidths (M_SRS) larger than the minimum SRS bandwidth, which is the minimum one of selectable candidates of SRS bandwidths, e.g. “4 RB” in the present embodiment. The flow proceeds to step S605 when a combination of SRS radio resources with SRS bandwidths (M_SRS) larger than the minimum SRS bandwidth is found in allocation results of SRS radio resources. In contrast, the flow proceeds to step S520 shown in FIG. 25 when a combination of SRS radio resources with SRS bandwidths (M_SRS) larger than the minimum SRS bandwidth is found in allocation results of SRS radio resources.

In step S605, the divisible SRS radio resource determination unit 2051 sets “0” to the flag Flag_req_Msrs. In step S606, a combination (M_SRS,i_SRS,j_SRS,k_c) of SRS radio resources with SRS bandwidths (M_SRS) larger than the minimum SRS bandwidth is selected as divisible SRS radio resources with divisible SRS bandwidths (M_SRS). Then, the flow proceeds to step S607.

In step S607, a decision is made as to whether or not a plurality of combinations (M_SRS,i_SRS,j_SRS,k_c) is selected as divisible SRS radio resources with divisible SRS bandwidths. When a plurality of combinations is selected as divisible SRS radio resources with divisible SRS bandwidths, the divisible SRS radio resource determination unit 2051 selects one of plural combinations of SRS radio resources each selected as divisible SRS radio resources with divisible SRS bandwidths. Then, the flow proceeds to step S651. In contrast, when a plurality of combinations is not selected as divisible SRS radio resources with divisible SRS bandwidths, the selected combination of SRS radio resources is used as divisible SRS radio resources with divisible SRS bandwidths. Then, the flow proceeds to step S651.

In step S608, the divisible SRS radio resource determination unit 2051 selects any of plural combinations (M_SRS,i_SRS,j_SRS,k_c) of SRS radio resources in accordance with one of three procedures as follows.
(a) A combination of SRS radio resources with a minimum cyclic shift is selected from among plural combinations (M_SRS,i_SRS,j_SRS,k_c) of SRS radio resources.
(b) A combination of SRS radio resources with a minimum SRS bandwidth (M_SRS) is selected from among plural combinations (M_SRS,i_SRS,j_SRS,k_c) of SRS radio resources.
(c) A combination of SRS radio resources with a maximum SRS bandwidth (M_SRS) is selected from among plural combinations (M_SRS,i_SRS,j_SRS,k_c) of SRS radio resources.

The procedure (a) minimizes the number of mobile terminal devices each allocated with a combination of divisible SRS radio resources with a divisible SRS bandwidth (M_SRS), thus minimizing the number of mobile terminal devices requiring a long time for obtaining communication quality per each frequency resource in the entire system frequency range. That is, it is possible to prevent a reduction of a frequency scheduling effect in the OFDMA system. Additionally, it is possible to reduce a load of processing signaling information that is used to notify a change of allocation with respect to the mobile terminal device 2004 allocated with a combination of SRS radio resources.

Similar to the procedure (a), the procedure (b) prevents a reduction of a frequency scheduling effect in the OFDMA system.

The procedure (c) increases the number of SRS radio resources which are vacant due to the foregoing operation of dividing the SRS bandwidth (M_SRS), thus reducing the frequency of dividing the SRS bandwidth (M_SRS).

Even when plural combinations of SRS radio resources still remain irrespective of the procedures (a) to (c), any one combination of SRS radio resources is selected as a combination of divisible SRS radio resources with a divisible SRS bandwidth (M_SRS) by way of the selective operation using the transmission comb (k_c), SRS transmission timing offset number (i_SRS), and SRS band offset number (j_SRS). Herein, one of plural combinations of SRS radio resources can be selected in a random manner or in ascending/descending order of the transmission comb (k_c), SRS transmission timing offset number (i_SRS), and the SRS band offset number (j_SRS).

In step S651, the SRS radio resource dividing unit 2052 makes a decision as to whether or not the flag Flag_req_Msrs is set to “1”. The flow proceeds to step S652 when the flag is set to “1”, whilst the flow proceeds to step S653 when the flag is set to “0”.

In step S652, the divisible SRS radio resource determination unit 2051 selects combinations of SRS radio resources allocated with desired SRS bandwidths Req_Msrs_DL(u) of mobile terminal devices 2004(u), among which the SRS radio resource dividing unit 2052 selects the largest desired SRS bandwidth, which is regarded as a new SRS bandwidth (M_SRS_selected) obtained by dividing the SRS bandwidth (M_SRS). In step S653, the SRS radio resource dividing unit 2052 selects the minimum SRS bandwidth as the new SRS bandwidth (M_SRS_selected).

In step S654, the SRS radio resource dividing unit 2052 changes the combination (M_SRS,i_SRS,j_SRS,k_c,k_s) of SRS radio resources, which the divisible SRS radio resource determination unit 2051 selects in step S608, with a new combination (M_SRS,i_SRS,j_SRS,k_c,k_s) of SRS radio resources, thus updating the SRS transmission scheduling table 2200 in response to a change of the combination of SRS radio resources. Then, the flow returns to step S512.

That is, the SRS radio resource dividing unit 2052 reduces only the SRS bandwidth but does not change other factors (i.e. the SRS transmission timing offset (i_SRS), SRS band offset number (j_SRS), transmission comb number (k_c), and cyclic shift number (k_s)) in the SRS transmission scheduling table 2200. Thus, the SRS radio resource dividing unit 2052 produces a vacancy of the SRS bandwidth setting information W_SRS(i_SRS,k_c), used for allocation of other mobile terminal devices, in the SRS transmission scheduling table 2200.

The flow proceeds to step S520 shown in FIG. 25 when no partial table TBL(i_SRS,k_c) is allocated to any one of available SRS bandwidths (M_SRS) with regard to the selected terminal device. For this reason, it is necessary to prepare a partial table TBL(i_SRS,k_c) for a minimum available SRS bandwidth (M_SRS) with regard to the selected terminal device.

In step S520, the SRS radio resource allocation unit 2015 selects a minimum available SRS bandwidth (M_SRS) with regard to the selected terminal device. Hereinafter, the selected SRS bandwidth (M_SRS) will be referred to as a selected minimum M_SRS.

In step S521, the SRS radio resource allocation unit 2015 searches for an unused partial table TBL(i_SRS,k_c) in the SRS transmission scheduling table 2200. Specifically, the SRS radio resource allocation unit 2015 searches for a combination (i_SRS,k_c) of the SRS transmission timing offset number (i_SRS) and the transmission comb number (k_c) with a vacancy of the SRS bandwidth setting information W_SRS(i_SRS,k_c) in the SRS transmission scheduling table 2200. In this connection, a partial table TBL(i_SRS,k_c) relating to the combination (i_SRS,k_c) of the SRS transmission timing offset number (i_SRS) and the transmission comb number (k_c) with a vacancy of the SRS bandwidth setting information W_SRS(i_SRS,k_c) is regarded as an unused partial table TBL(i_SRS,k_c).

Next, the SRS radio resource allocation unit 2015 makes a decision as to whether or not the unused partial table TBL(i_SRS,k_c) exists in the SRS transmission scheduling table 2200. The flow proceeds to step S523 when the unused partial table TBL(i_SRS,k_c) is found, whilst the flow proceeds to step S511 shown in FIG. 22 when the unused partial table TBL(i_SRS,k_c) is not found.

In step S523, the SRS radio resource allocation unit 2015 selects a combination of SRS radio resource, i.e. (j_SRS,k_s)=(0,0), with a minimum vacancy residue (k_c) of SRS radio resources and a minimum SRS transmission timing offset number (i_SRS) in the unused partial table TBL(i_SRS,k_c). This aims to leave as many unused transmission combs as possible. Since unused transmission combs can be used for data transmission other than SRS transmission, unused transmission combs likely contribute to the effective utilization of radio resources.

In step S524, the SRS radio resource allocation unit 2015 describes the identification number of the selected mobile terminal device as the allocated terminal number 2210 in the column of the combination of SRS radio resource, i.e. (j_SRS,k_s)=(0,0), selected from the unused partial table TBL(i_SRS,k_c) in step S523. Additionally, the selected minimum M_SRS is set to the SRS bandwidth setting information W_SRS(i_SRS,k_c) in the unused partial table TBL(i_SRS,k_c), so that the unused partial table TBL(i_SRS,k_c) is dedicated to the selected minimum M_SRS. Thus, a combination (selected minimum M_SRS, i_SRS, j_SRS=0, ks=0, k_c) of SRS radio resources, corresponding to the combination (j_SRS,k_s)=(0,0) of SRS radio resources in the selected minimum M_SRS partial table TBL(i_SRS,k_c), is allocated to the selected mobile terminal device. Thereafter, the flow returns to step S504 shown in FIG. 22.

In the present embodiment, when no partial table TBL(i_SRS,k_c) can be allocated to any one of available SRS bandwidths (M_SRS) with regard to a new mobile terminal device, the SRS band dividing unit 2005 selects a combination of divisible SRS radio resources with a divisible (or narrow) SRS bandwidth from among already allocated combinations of SRS radio resources. Then, the SRS band dividing unit 2005 divides the SRS bandwidth assigned to the selected combination of SRS radio resources, thus providing a vacant partial table TBL(i_SRS,k_c). The SRS transmission scheduling unit 2002 allocates a new mobile terminal device to the vacant partial table TBL(i_SRS,k_c) newly provided by the SRS band dividing unit 2005.

Thus, it is possible to allocate an appropriate combination of SRS radio resources to a newly connected mobile terminal device irrespective of tightness of SRS radio resources. This makes it possible to measure frequency characteristics established between the newly connected mobile terminal device 2004 and the base station device 2001 by use of a sound reference signal (SRS), so that frequency scheduling is performed in response to measured frequency characteristics. Thus, it is possible to improve throughput of the mobile terminal device 2004, thus further improving the communication capacity of the OFDMA system.

The present embodiment is designed in such a way that, when no combination of divisible SRS radio resources with a divisible (or narrow) SRS bandwidth (M_SRS) is found in step S601, a combination of SRS radio resources with an SRS bandwidth (M_SRS) larger than the minimum SRS bandwidth is selected as a combination of divisible SRS radio resources with a divisible SRS bandwidth (M_SRS) in step S604; but this is not a restriction. It is possible to modify the present embodiment such that, when no combination of divisible SRS radio resources with a divisible (or narrow) SRS bandwidth (M_SRS) is found in step S601, the flow proceeds to step S520 shown in FIG. 25. This makes it possible to allocate a larger SRS bandwidth, larger than the minimum SRS bandwidth determined by the minimum SRS bandwidth determination unit 2012, to the mobile terminal device 2004, thus securing frequency scheduling with an adequate communication quality.

The present embodiment is designed in such a way that the largest SRS bandwidth, selected from among desired SRS bandwidths Req_Msrs_DL(u) of mobile terminal devices 2004(u), is used as the divided SRS bandwidth (M_SRS_selected) in step S652; but this is not a restriction. If the base station device 2001 succeeds to reduce the divisible SRS bandwidth, assigned to the combination of divisible SRS radio resources selected by the divisible SRS radio resource determination unit 2051, so as to create a combination of SRS radio resources allocable to the other mobile terminal device 2004, it is possible to determine a divided SRS bandwidth which is larger than MAXᵤ{SRS bandwidth Req_Msrs_DL(u)}. That is, it is possible to divide (or reduce) the selected SRS bandwidth to be larger than the lower limit of MAXᵤ{SRS bandwidth Req_Msrs_DL(u)}.

The base station device 2001 can be equipped with a computer system therein. In this case, the foregoing processes included in the flowcharts shown in FIGS. 22 to 25 are stored as programs in computer-readable recording media, so that the computer system reads and loads those programs to implement the foregoing processes. Herein, the term “computer-readable recording media” refer to magnetic disks, magnetooptic disks, CD-ROM, DVD-ROM, semiconductor memory or the like. In this connection, programs may be distributed to the computer system via communication lines so that the compute system can execute programs.

As described heretofore, the present invention is not necessarily limited to the foregoing embodiments, which can be further modified in various ways within the scope of the invention as defined in appended claims.

What is claimed is:

1. A wireless communication system including a first base station device, a second base station device, a first terminal device having a connection permission with the first base station device, and a second terminal device which does not have the connection permission with the first base station device but which is connectible to the second base station device by use of a same frequency range as a frequency range by which the first terminal device is connected to the first base station device, said first base station device comprising:
a first approach decision unit that makes a decision as to whether or not the second terminal device is located in a communication area of the first base station device;
a first allocation control unit that allocates a first frequency band, depending upon a radio quality of communication conducted between the first terminal device and the first base station device, to the first terminal device when the first approach decision unit determines that the second terminal device is not located in the communication area, whilst said first allocation control unit allocates a narrow frequency band, narrower than the first frequency band, to the first terminal device when the first approach decision unit determines that the second terminal device is located in the communication area; and
a first wireless communication unit that transmits a control signal, representing allocation of a traffic channel, to the first terminal device by use of the first frequency band or the narrow frequency band which the first allocation control unit allocates to the first terminal device.

2. The wireless communication device according to claim 1, wherein said first base station device further comprises
a correspondence table storage unit that stores the radio quality of communication, conducted between the first terminal device and the first base station device, in connection with an SINR (Signal to Interference and Noise Ratio) value satisfying the radio quality of communication, and
a transmission power calculation unit that sets a default value of transmission power in transmitting the control signal to the first terminal device when the first approach decision unit determines that the second terminal device is not located in the communication area of the first base station device, whilst when the first approach decision unit determines that the second terminal device is located in the communication area, said transmission power calculation unit reads a target SINR value, corresponding to a target radio quality of communication, and a current SINR value, corresponding to the radio quality of communication currently established with the first terminal device, from the correspondence table storage unit, so that the transmission power calculation unit modifies the default value of transmission power based on a bias value, corresponding to a difference between the target SINR value and the current SINR value, so as to adopt the modified default value of transmission power in transmitting the control signal to the first terminal device via the first wireless communication unit.

3. The wireless communication system according to claim 1, wherein said second base station device comprises
a second approach decision unit that makes a decision as to whether or not the second terminal device, which is connected to the second base station device, is located in the communication area of the first base station device,
a second allocation control unit that allocates a second frequency band, depending upon a radio quality of communication conducted between the second terminal device and the second base station device, to the second terminal device when the second approach decision unit determines that the second terminal device is not located in the communication area, whilst said second allocation control unit allocates a broad frequency band, broader than the second frequency band, to the second terminal device when the second approach decision unit determines that the second terminal device is located in the communication area, and
a second wireless communication unit that transmits the control signal to the second terminal device by use of the second frequency band or the broad frequency band which the second allocation control unit allocates to the second terminal device.

4. The wireless communication system according to claim 3, wherein said second base station device further comprises a second handoff control unit that transmits a handoff request, establishing a connection with the second terminal device, to the first base station device so that the first base station device accepts or declines the handoff request by sending back a message to the second base station device, and wherein the second approach decision unit detects the number of messages declining handoff requests in a predetermined preceding time period, whereby the second approach decision unit determines that the second terminal device is located in the communication area of the first base station device when the detected number of message declining handoff requests is equal to or above a predetermined threshold, whilst the second approach decision unit determines that the second terminal device is not located in the communication area when the detected number of messages declining handoff requests is less than the predetermined threshold.

5. The wireless communication system according to claim 1, wherein said first base station device further comprises a first handoff control unit that receives the handoff request, establishing the connection with the second terminal device, so as to send back the message declining the handoff request to the second base station device, and wherein said first approach decision unit detects the number of messages declining handoff requests in a predetermined preceding time period, whereby the first approach decision unit determines that the second terminal device is located in the communication area of the first base station device when the detected number of messages declining handoff requests is equal to or above a predetermined threshold, whilst the first approach decision unit determines that the second terminal device is not located in the communication area when the detected number of messages declining handoff requests is less than the predetermined threshold.

6. A base station device adapted to a wireless communication system accommodating a first terminal device having a connection permission and a second terminal device not having the connection permission, comprising:
an approach decision unit that makes a decision as to whether or not the second terminal device is located in a communication area;
an allocation control unit that allocates a frequency band, depending upon a radio quality of communication conducted with the first terminal device, to the first terminal device when the approach decision unit determines that the second terminal device is not located in the communication area, whilst the allocation control unit allocates a narrow frequency band, narrower than the frequency band, to the first terminal device when the approach decision unit determines that the second terminal device is located in the communication area; and
a wireless communication unit that transmits a control signal, representing allocation of a traffic channel, to the first terminal device by use of the frequency band or the narrow frequency band.

7. A wireless communication method adapted to a wireless communication system including a first base station device, a second base station device, a first terminal device having a connection permission with the first base station device, and a second terminal device which does not have the connection permission with the first base station device but which is connectible to the second base station device by use of a same frequency range as a frequency range by which the first terminal device is connected to the first base station device, comprising:
making a decision, by the first base station device, as to whether or not the second terminal device is located in a communication area of the first base station device;
allocating a first frequency band, depending upon a radio quality of communication conducted between the first terminal device and the first base station device, to the first terminal device when it is determined that the second terminal device is not located in the communication area;
allocating a narrow frequency band, narrower than the first frequency band, to the first terminal device when it is determined that the second terminal device is located in the communication area; and
transmitting a control signal, representing allocation of a traffic channel, to the first terminal device by use of the first frequency band or the narrow frequency band which is allocated to the first terminal device.

8. A program causing a computer to implement a wireless communication method adapted to a wireless communication system including a first base station device, a second base station device, a first terminal device having a connection permission with the first base station device, and a second terminal device which does not have the connection permission with the first base station device but which is connectible to the second base station device by use of a same frequency range as a frequency range by which the first terminal device is connected to the first base station device, said wireless communication method comprising:
making a decision, by the first base station device, as to whether or not the second terminal device is located in a communication area of the first base station device;
allocating a first frequency band, depending upon a radio quality of communication conducted between the first terminal device and the first base station device, to the first terminal device when it is determined that the second terminal device is not located in the communication area;
allocating a narrow frequency band, narrower than the first frequency band, to the first terminal device when it is determined that the second terminal device is located in the communication area; and
transmitting a control signal, representing allocation of a traffic channel, to the first terminal device by use of the first frequency band or the narrow frequency band which is allocated to the first terminal device.

9. A base station device which is able to communicate with a registered terminal device except for an unregistered terminal device, comprising:
an unregistered terminal device decision unit that makes a decision as to whether or not the unregistered terminal device exists in a coverage area;
an antenna transmission mode determination unit that determines an antenna transmission mode based on a decision result of the unregistered terminal device decision unit;
a scheduler mode determination unit that determines a scheduler mode based on the decision result of the unregistered terminal device decision unit; and
an OFDM symbol determination unit that determines the number of OFDM symbols, which a physical control channel utilizes to notify radio resource allocation information, based on the decision result of the unregistered terminal device decision unit.

10. The base station device according to claim 9, wherein the antenna transmission mode determination unit determines the antenna transmission mode based on the number of embedded antennas when the unregistered terminal device decision unit determines that the unregistered terminal device does not exist in the coverage area, whilst the antenna transmission mode determination unit determines the antenna transmission mode based on existence or nonexistence of antenna information regarding the number of antennas installed in a secondary base station device which the unregistered terminal device communicates with when the unregistered terminal device decision unit determines that the unregistered terminal device exists in the coverage area.

11. The base station device according to claim 10, wherein when the unregistered terminal device decision unit determines that the unregistered terminal device exists in the coverage area, the antenna transmission mode determination unit selects a single antenna transmission mode owing to the nonexistence of the antenna information, whilst the antenna transmission mode determination unit determines the antenna transmission mode based on the relationship between the number of embedded antennas and the number of antennas installed in the secondary base station device owing to the existence of the antenna information.

12. The base station device according to claim 11, wherein the antenna transmission mode determination unit determines the single antenna transmission mode with a desired antenna port indicating a higher average value of Wideband CQI (Wideband Channel Quality) fed back thereto.

13. The base station device according to claim 9, wherein the scheduler mode determination unit selects a dynamic scheduler mode when the unregistered terminal device decision unit determines that the unregistered terminal device does not exist in the coverage area, whilst the scheduler mode determination unit selects a semi-persistent scheduler mode when the unregistered terminal device decision unit determines that the unregistered terminal device exists in the coverage area.

14. The base station device according to claim 13, wherein after selecting the semi-persistent scheduler mode, the scheduler mode determination unit changes the semi-persistent scheduler mode with the dynamic scheduler mode periodically or in an event-driven manner.

15. The base station device according to claim 9, wherein the OFDM symbol determination unit sets a non-zero number to the number of OFDM symbols when the unregistered terminal device decision unit determines that the unregistered terminal device does not exist in the coverage area, whilst the OFDM symbol determination unit sets zero to the number of OFDM symbols when the unregistered terminal device decision unit determines that the unregistered terminal device exists in the coverage area.

16. The base station device according to claim 15, wherein the OFDM symbol determination unit changes the number of OFDM symbols from zero to a non-zero number periodically or in an event-driven manner.

17. A program causing a computer to implement a functionality of a base station device which is able to communicate with a registered terminal device except for an unregistered terminal device, comprising:
making a decision as to whether or not the unregistered terminal device exists in a coverage area;
determining an antenna transmission mode based on the decision result;
determining a scheduler mode based on the decision result; and
determining the number of OFDM symbols, which a physical control channel utilizes to notify radio resource allocation information, based on the decision result.

18. A base station device comprising:
a transmission scheduling table that stores allocation information of radio resources representing frequencies and bandwidths used for transmission of sounding reference signals (SRS) with regard to mobile terminal devices;
a divisible radio resource determination unit that makes a decision as to whether or not a selected mobile terminal device is allocable with a combination of divisible radio resources with a divisible bandwidth with reference to the transmission scheduling table;
a divisible radio resource dividing unit that divides the divisible bandwidth of the combination of divisible radio resources allocated to the selected mobile terminal device, thus producing a vacancy of radio resources; and
a radio resource allocation unit that allocates the vacancy of radio resources to another mobile terminal device.

19. The base station device according to claim 18 further comprising a minimum bandwidth determination unit that determines a minimum value of a bandwidth with regard to each combination of radio resources based on mobility of each mobile terminal device, wherein the divisible radio resource determination unit determines the selected mobile terminal device to be allocated with the combination of divisible radio resources with the divisible bandwidth which is larger than the minimum value of the bandwidth determined by the minimum bandwidth determination unit, so that the radio resource dividing unit reduces the divisible bandwidth of the combination of divisible radio resources allocated to the selected mobile terminal device.

20. The base station device according to claim 18, wherein the divisible radio resource determination unit selects one of plural combinations of divisible radio resources with divisible bandwidths such that the selected combination of divisible radio resources is allocable to the minimum number of mobile terminal devices.

21. The base station device according to claim 18, wherein the divisible radio resource determination unit selects one of plural combinations of divisible radio resources with divisible bandwidths such that the divisible bandwidth in the selected combination of radio resources is minimum or maximum.

22. The base station device according to claim 18, wherein the radio resource allocation unit allocates the vacancy of radio resources to transmission of sounding reference signals (SRS).

23. A band allocation method adapted to a base station device having a transmission scheduling table that stores allocation information of radio resources representing frequencies and bandwidths used for transmission of sounding reference signals (SRS) with regard to mobile terminal devices, said band allocation method comprising:
making a decision as to whether or not a selected mobile terminal device is allocable with a combination of divisible radio resources with a divisible bandwidth with reference to the transmission scheduling table;
dividing the divisible bandwidth of the combination of divisible radio resources allocated to the selected mobile terminal device, thus producing a vacancy of radio resources; and
allocating the vacancy of radio resources to another mobile terminal device.

24. A program causing a computer of a base station device to implement a band allocation method comprising:
storing allocation information of radio resources representing frequencies and bandwidths used for transmission of sounding reference signals (SRS) with regard to mobile terminal devices in a transmission scheduling table;
making a decision as to whether or not a selected mobile terminal device is allocable with a combination of divisible radio resources with a divisible bandwidth with reference to the transmission scheduling table;
dividing the divisible bandwidth of the combination of divisible radio resources allocated to the selected mobile terminal device, thus producing a vacancy of radio resources; and
allocating the vacancy of radio resources to another mobile terminal device.
